(19) United States
(12) Patent Application Publication
(10) Pub. No.: US 2005/0246174 A1
(43) Pub. Date: Nov. 3, 2005

(54) Method and system for presenting dynamic commercial content to clients interacting with a voice extensible markup language system

(76) Inventor: Richard C. DeGolia, Atherton, CA (US)

Correspondence Address: CENTRAL COAST PATENT AGENCY, PO BOX 187, AROMAS, CA, 95004, US

(21) Appl. No.: 11/155,701

(22) Filed: Jun. 16, 2005

Related U.S. Application Data
(63) Continuation-in-part of application No. 10/861,078, filed on Jun. 4, 2004.
Application No. 10/861,078 is a continuation-in-part of application No. 10/835,444, filed on Apr. 28, 2004.
(60) Provisional application No. 60/581,924, filed on Jun. 21, 2004.

(51) Int. Cl. G10L 21/00

(52) U.S. Cl. 704/270

(57) ABSTRACT

A system for selecting a voice dialog, which may be an advertisement or information message, from a pool of voice dialogs and for causing the selected voice dialog to be utilized by a voice application for presentation to a caller during an automated voice interactive session includes a voice-enabled interaction interface hosting the voice application; and, a sever monitoring the voice-enabled interaction interface for selecting the voice dialog and for serving at least identification and location of the dialog to be presented to the caller via the voice application.

### CROSS-REFERENCE TO RELATED DOCUMENTS

The instant application claims priority to provisional application Ser. No. 60/581,924, filed on Jun. 21, 2004. The present invention is also a continuation in part (CIP) of U.S. patent application Ser. No. 10/861,078, entitled “Method for Creating and Deploying System Changes in a Voice Application System” filed on Jun. 4, 2004, which is a CIP to a U.S. patent application Ser. No. 10/835,444, entitled “System for Managing Voice Files of a Voice Prompt Server” filed on Apr. 28, 2004. The disclosures of the above applications are included herein in their entirety at least by reference.

### FIELD OF THE INVENTION

The present invention is in the area of voice application software systems and pertains particularly to systems for managing voice files linked for service to a voice application deployment system, and more particularly, selecting and presenting voice files of commercial content to callers interacting with a voice system interface.

### BACKGROUND OF THE INVENTION

A speech application is one of the most challenging applications to develop, deploy and maintain in a communications environment. Expertise required for developing and deploying a viable voice-extensible-markup-language (VXML) application, for example, includes expertise in computer telephony integration (CTI) hardware and software or a data network telephony (DNT) equivalent, voice recognition software, text-to-speech software (TTS), and speech application logic.

With the relatively recent advent of VXML, the expertise required to develop a speech solution has been reduced somewhat. VXML is a language that enables a software developer to focus on the application logic of the voice application without being required to configure underlying telephony components. Typically, the developed voice application is run on a VXML interpreter that resides and executes on the associated telephony system to deliver the solution.

Voice prompting systems in use today range from a simple interactive voice response (IVR) systems for telephony to the more state-of-art VXML application system known to the inventor. Anywhere a customer telephony interface may be employed there may also be a voice interaction system in place to interact with callers in real time. DNT equivalents of voice delivery systems also exist, like VoIP portals and the like.

Often in both VXML compliant and non-VXML systems, such as CTI, IVRs and VoIP IVRs, voice messaging services and the like, voice prompts are sometimes prerecorded in a studio setting for a number of differing business scenarios and uploaded to the enterprise system server architecture for access and deployment during actual interactions with callers. Pre-recording voice prompts instead of dynamically creating them through software and voice synthesis methods is many times performed when better sound quality, different languages, different voice types, or a combination of the above, are desired for the presentation logic of a particular system.

In very large enterprise architectures there may be many thousands of prerecorded voice prompts stored for use by a given voice application. Some of these may not be stored in the same centralized location. One with general knowledge of voice file management will attest that managing such a large volume of voice prompts can be very complicated. For example, in prior-art systems management of voice prompts includes recording the prompts, managing identification of those prompts and manually referencing the required prompts in the application code used in developing the application logic for deployment of those prompts to a client interfacing system. There is much room for error in code referencing and the actual development, recording, and sorting batches of voice files can be error prone and time consuming.

The inventor knows of a software interface for managing audio resources used in one or more voice applications. The software interface includes a first portion for mapping the audio resources from storage to use-case positions in the one or more voice applications, a portion for accessing the audio resources according to the mapping information and for performing modifications, a portion for creating new audio resources; and a portion for replication of modifications across distributed facilities. In a preferred application, a developer can modify or replace existing audio resources and replicate links to the application code of the applications that use them.

VXML-compliant and other types of voice systems may frequently need to be modified or updated, sometimes multiple times per day, due to fast-paced business environments, rapidly evolving business models, special temporary product promotions, sales discounts, specific requirements or interests of the caller and so on. For example, if a product line goes obsolete, existing voice prompts related to that product line that are operational in a deployed voice application may need to be modified, replaced or simply deleted. Moreover, configuration settings of a voice application interaction system may also need to be updated or modified from time to time due to the addition of new or modified hardware, software, and so on.

The software application mentioned above, as known to the inventor, for managing audio resources enables frequent modifications of existing voice applications in a much improved and efficient manner, as compared to the current art. However, when changing over from an existing configuration to a new configuration the running voice application is typically suspended from service while the changes are implemented. Shutting down service for even a temporary period can result in monetary losses that can be significant depending on the amount of time the system will be shut down. In some cases a backup system may be deployed while the primary system is being reconfigured. However, this approach requires more resources than would be required to run one application.

The inventor knows of a system for configuring and implementing changes to a voice application system. The system includes a first software component and host node for configuring one or more changes; a second software component and host node for receiving and implementing the configured change or changes; and a data network connecting the host nodes. In a preferred embodiment, a pre-configured change-order resulting from the first software component and host node is deployed after pre-configuration, deployment and execution thereof requiring only one action. In this system changes may be implemented while the target application is running and servicing callers.

While the developments above provide a more rich and dynamic VXML experience for callers with more efficiency afforded to service providers, it has occurred to the inventor that the technologies cited above could be made to provide a vehicle for advertising and/or the delivery of informative messages that does not now exist in present art systems or services.

Advertisements are a large and important part of business when related to applications that make a communicative interface with callers or clients (collectively, callers) of an enterprise. For example, during normal interaction with callers, a business may desire to communicate new opportunities, such as service or product upgrades, the availability of new products or services, informative messaging that may be deemed to improve customer service or loyalty and the like. For example, in telephone communication a static IVR greeting may first play an advertisement directed to callers and may include an option for ignoring or pursuing the advertisement to fulfillment. Likewise, media downloaded from a Web site, for example, may contain advertisements which load and play in a media application before the content of the user's choice is loaded and played whether live content or not.

The ad server, based on some user input or behavioral activity, may dynamically select any available HTML ad, typically delivered to client interfaces by the server during a network session. For example, if a user clicks on a fishing article, or is searching using a search engine for articles about fishing, a dynamic ad server containing a variety of sporting ads ranging from golf to sailing may select and cause a fishing resort ad to be delivered to the client interface based on the on-line behavior of the client. Moreover, such dynamic ad serving may also be based on previously known data about the caller.

In a voice response system, whether VXML-enabled or not, any advertisements that are played may be part of the static menu navigation system and may be the same ads played regardless of who is interacting with the system. While there may be more than one advertisement in a menu that may be delivered if a caller so chooses, these ads are static ads that do not change from client to client.

What is clearly needed in the art is a dynamic ad and/or messaging server and system that dynamically selects and implements advertisements for delivery to callers in a voice-based interaction interface, such as in a VXML application interface, from a pool of such available advertisements, with such selection of specific advertisements based on the caller's actual behavior in the system and/or based on previoulsy known client data.

### SUMMARY OF THE INVENTION

According to embodiments of the present invention, a system for selecting a voice dialog, which may be an advertisement or information message, from a pool of voice dialogs and for causing the selected voice dialog to be utilized by a voice application for presentation to a caller during an automated voice interactive session is provided. The system includes, a voice-enabled interaction interface hosting the voice application, and a sever monitoring the voice-enabled interaction interface for selecting the voice dialog and for serving at least identification and location of the dialog to be presented to the caller via the voice application.

In one embodiment, the voice-enabled interaction interface is an interactive voice response unit hosted in a telephone network. In another embodiment, the voice-enabled interaction interface is a voice portal hosted on one of the Internet, an Intranet, or on a Local Area Network.

In one embodiment, the voice application is a Voice Extensible Markup Language-based application and the voice interface is VXML-enabled. Also in one embodiment, the server is a software instance running on a node separate from but having network access to the voice-enabled interaction interface. In another embodiment, the server is a software instance running on the voice-enabled interaction interface.

In one embodiment, the voice dialogs comprise one or more text scripts that are recognized and executed as voice using a text-to-speech conversion method when presented to a caller. In another embodiment, the voice dialogs comprise one or more pre-recorded or dynamically recorded voice files, including voice application code for enabling interaction with the voice dialog.

In one embodiment, the host running the voice application retrieves and presents a selected voice dialog based on served identification and location information of the voice dialog. In a preferred embodiment, the sever retrieves and serves the voice dialog to the host running the voice application whereupon the voice application then presents the voice dialog to the caller in the voice-enabled interaction.

In one embodiment, the voice application code references a pool of two or more voice dialogs and the server selects which voice dialog from the pool will be presented based on analysis of caller data against a set of rules.

According to another aspect of the present invention, a software instance for selecting a voice dialog, which may be an advertisement or an information message, from a pool of voice dialogs and for causing the selected voice dialog to be utilized by a voice application for presentation to a caller during an automated interactive voice session with the caller is provided. The software instance includes a portion for accepting and analyzing data about the caller, a portion for selecting a voice dialog, and a portion for serving at least identification and location of the selected voice dialog to the voice application.

In one embodiment, the voice application is deployed to and executable on an interactive voice response unit hosted in one of a telephone network, an Intranet network, or a Local Area Network. In another embodiment, the voice application is deployed to and executable on a voice portal hosted on the Internet network. Also in one embodiment, the voice application is a Voice Extensible Markup Language-based application and the voice interface is VXML-enabled.

In another embodiment, the software instance is installed and executable from a node separate from but having network access to the voice-enabled interaction interface. In still another embodiment, the software instance is installed and executable from the voice-enabled interaction interface.

In one embodiment, the voice dialogs comprise one or more text scripts that are recognized and executed as voice using a text-to-speech conversion method when presented to a caller. In another embodiment, the voice dialogs comprise one or more pre-recorded or dynamically recorded voice files including voice application code for enabling interaction with the voice dialog.

In a preferred embodiment, the portion for accepting and analyzing data about the caller accepts historical data about the caller. Also in a preferred embodiment, the data about the caller may include one or a combination of profile data, historical data, including historical activity, historical behavioral data, and real time behavioral data.

In one embodiment, the portion for selecting a voice dialog utilizes the caller data, a set of rules, and the location reference to the voice dialog pool. In a variation of this embodiment, the portion for serving the selected voice dialog serves the actual resource files and application code of the selected voice dialog. In a preferred embodiment, the portion for accepting and analyzing data about the caller executes an algorithm that compares data about the caller against a set of rules.

In yet another aspect of the present invention, a method for selecting a voice dialog, which may be an advertisement or an information message, from a voice dialog pool for use in an automated voice session presentation to a caller is provided and includes steps for (a) identifying the caller; (b) accepting data about the caller; (c) analyzing the accepted data and consulting at least one rule; and (d) selecting a voice dialog based on the result of consultation.

In one aspect, in step (a), the caller is identified by one or a combination of telephone number, password, or personal identification information. In one aspect, in step (b), data about the caller is forwarded to the host machine executing the method wherein the data is static data known about the caller. In still another aspect, in step (b), data about the caller is forwarded to the host machine executing the method wherein the data is one or a combination of profile data, historical data, including historical activity, historical behavioral data, and real time behavioral data.

In one aspect, in step (b), the behavioral data includes navigation data observed during caller navigation of at least one voice application menu option. In a preferred aspect, in step (c), an algorithm compares data results against the at least one rule and in step (d), the selection is made according to results of the comparison.

In still another aspect of the present invention, a method for causing a voice dialog, which may be an advertisement or an information message, selected from a voice dialog pool to execute in an interactive voice application in a state of interaction with a caller is provided and includes steps for (a) serving at least identification and location information of the selected voice dialog to the voice application; (b) upon receipt of the identification and location information, retrieving the voice dialog from its location reference in the pool; (c) upon receipt of the voice dialog, inserting same into the voice application; and, (d) executing the voice dialog to play for the caller.

In one aspect, in step (a), the identification and location information is referenced in the voice application code that also references the specific pool of voice dialogs. Also in one aspect in step (a) the identification and location information is available from a dialog index associated with the voice dialog pool, the index providing identification and location for all of the voice dialogs in the pool.

According to another aspect, in step (b), the pool is a logical association of voice dialogs located in different physical hosts accessible over one of an Internet, an Intranet or a Local Area Network. In one aspect, wherein in step (b), the pool is a physical pool of voice dialogs located in a same physical host. In a preferred aspect, in step (c), the voice dialog has linking and execution code therein for attaching to a dialog insertion point in a voice application and executing the voice dialog once attached.

### BRIEF DESCRIPTION OF THE DRAWING FIGURES

FIG. 1 is a logical overview of a voice interaction server and voice prompt data store according to prior-art.

FIG. 2 is a block diagram illustrating voice prompt development and linking to a voice prompt application according to prior art.

FIG. 3 is a block diagram illustrating a voice prompt development and management system according to an embodiment of the present invention.

FIG. 4 illustrates an interactive screen for a voice application resource management application according to an embodiment of the present invention.

FIG. 5 illustrates an interactive screen having audio resource details and dependencies according to an embodiment of the present invention.

FIG. 6 illustrates an interactive screen for an audio resource manager illustrating further details and options for editing and management according to an embodiment of the present invention.

FIG. 7 is a process flow diagram illustrating steps for editing or replacing an existing audio resource and replicating the resource to distributed storage facilities.

FIG. 8 is an architectural overview of a communications network wherein automated voice application system configuration is practiced according to an embodiment of the present invention.

FIG. 9 is an exemplary screenshot illustrating application of modifications to a voice dialog according to an embodiment of the present invention.

FIG. 10 is a block diagram illustrating components of an automated voice application configuration application according to an embodiment of the present invention.

FIG. 11 is a process flow chart illustrating steps for receiving and implementing a change-order according to an embodiment of the present invention.

FIG. 12 is an architectural overview of a communication network wherein dynamic ad selection and service is practiced according to an embodiment of the present invention.

FIG. 13 is a block diagram illustrating components of a dynamic ad server according to an embodiment of the present invention.

FIG. 14 is a block diagram illustrating logical system interaction points between a dynamic ad server and a client according to an embodiment of the present invention.

FIG. 15 is a process flow chart illustrating steps for selecting and serving a dynamic ad based on client information according to an embodiment of the present invention.

### DESCRIPTION OF THE PREFERRED EMBODIMENTS

The inventor provides a system for managing voice prompts in a voice application system. Detail about methods, apparatus and the system as a whole are described in enabling detail below.

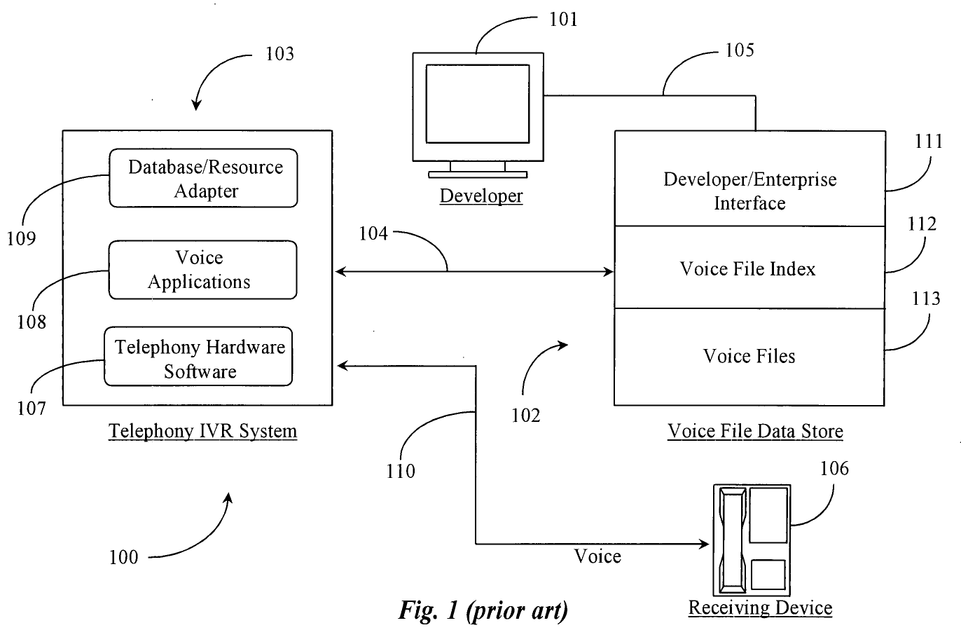

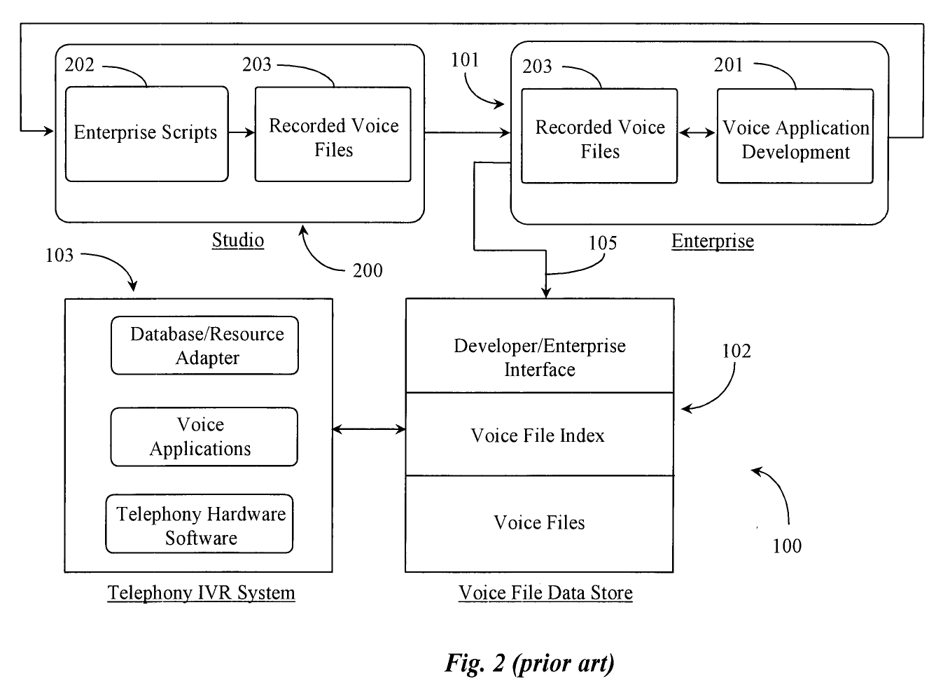

FIG. 1 is a logical overview of a voice interaction server and voice prompt data store according to prior art. FIG. 2 is a block diagram illustrating voice prompt development and linking to a voice prompt application according to prior art. A voice application system 100 includes a developer 101, a voice file storage medium 102, a voice portal (telephony, WVR) 103, and one of possibly hundreds or thousands of receiving devices 106.

Device 106 may be a LAN-line telephone, a cellular wireless device, or any other communication device that supports voice and text communication over a network. In this example, device 106 is a plain old telephone service (POTS) telephone.

Device 106 has access through a typical telephone service network, represented herein by a voice link 110, to a voice system 103, which in this example is a standard telephony IVR system. IVR system 103 is the customer access point for callers (device 106) to any enterprise hosting or leasing the system.

IVR 103 has a database/resource adapter 109 for enabling access to off system data. IVR also has voice applications 108 accessible therein and adapted to provide customer interaction and call flow management. Applications 108 include the capabilities of prompting a customer, taking input from a customer and playing prompts back to the customer depending on the input received.

Telephony hardware and software 107 includes the hardware and software that may be necessary for customer connection and management of call control protocols. IVR 103 may be a telephony switch enhanced as a customer interface by applications 108. Voice prompts executed within system 103 may include only prerecorded prompts. A DNT equivalent may use both prerecorded prompts and XML-based scripts that are interpreted by a text-to-speech engine and played using a sampled voice.

IVR system 103 has access to a voice file data store 102 via a data link 104, which may be a high-speed fiber optics link or another suitable data carrier many of which are known and available. Data store 102 is adapted to contain prerecorded voice files, sometimes referred to as prompts. Prompts are maintained, in this example, in a section 113 of data store 102 adapted for the purpose of storing them. A voice file index 112 is illustrated and provides a means for searching store section 113 to access files for transmission over link 104 to IVR system 103 to be played by one of applications 108 during interaction with a caller.

In this case IVR system 102 is a distributed system such as to a telephony switch location in a public switched telephone network (PSTN) and therefore is not equipped to store many voice files, which take up considerable storage space if they are high quality recordings.

Data store 111 has a developer/enterprise interface 111 for enabling developers such as developer 101, access for revising existing voice files and storing new and deleting old voice files from the data store. Developer 101 may create voice applications and link stored voice files to the application code for each voice application created and deployed. Typically, the voice files themselves are created in a separate studio from script provided by the developer.

As was described with reference to the background section, for a large enterprise there may be many thousands of individual voice prompts, many of which are linked together in segmented prompts or prompts that are played in a voice application wherein the prompts contain more than one separate voice files. Manually linking the original files to the application code, when creating the application, provides enormous room for human error. Although the applications are typically tested before deployment, errors may still get through, causing monetary loss at the point of customer interface.

Another point of human management is between the studio and the developer. The studio has to manage the files and present them to the developer in a fashion that the developer can manipulate in an organized fashion. As the number of individual prerecorded files increases, so does the complexity of managing those prerecorded files.

Referring now to FIG. 2, developer 101 engages in voice application development activity 201. Typically voice files are recorded from script. Therefore, for a particular application developer 101 creates enterprise scripts 202 and sends them out to a recording studio (200) to be recorded. An operator within the recording studio 200 receives scripts 202 and creates recorded voice files 203. Typically, the files are single segments, some of which may be strategically linked together in a voice application to play as a single voice prompt to a caller as part of a dialog executed from the point of IVR 103, for example.

The enterprise must insure that voice files 203 are all current and correct and that the parent application has all of the appropriate linking in the appropriate junctions so that the desired voice files may be called up correctly during execution. Developer 101 uploads files 203 when complete to data store 102 and the related application may also be uploaded to data store 102. When a specific application needs to be run at a customer interface, it may be distributed without the voice files to the point of interface, in this case IVR 103. There may be many separate applications or sub-dialogs that use the same individual voice files. Often there will be many instances of the same voice file stored in data store 102 but linked to separate applications that use the same prompt in some sequence.

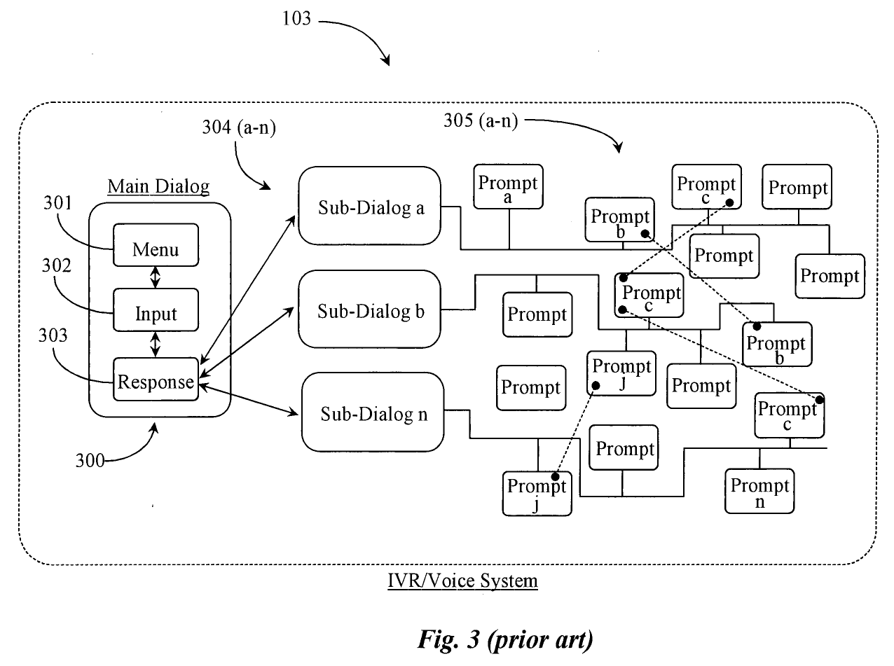

FIG. 3 is an expanded view of IVR 103 of FIG. 2 illustrating a main dialog and sub-dialogs of a voice application according to prior art. In many systems, a main dialog 300 includes a static interactive menu 301 that is executed as part of the application logic for every caller that calls in. During playing of menu 300, a caller may provide input 302, typically in the form of voice for systems equipped with voice recognition technology. A system response 303 is played according to input 302.

System response 303 may include as options, sub-dialogs 304(a-n). Sub-dialogs 304(a-n) may link any number of prompts, or voice files 305(a-n) illustrated logically herein for each illustrated sub-dialog. In this case prompt 305b is used in sub-dialog 304 a and in sub-dialog 304b. Prompt 305c is used in all three sub-dialogs illustrated. Prompt 305a is used in sub-dialog 304b and in sub-dialog 304b. Most prompts are created at the time of application creation and deployment. Therefore prompts 305b, c, and j are stored in separate versions and locations for each voice application.

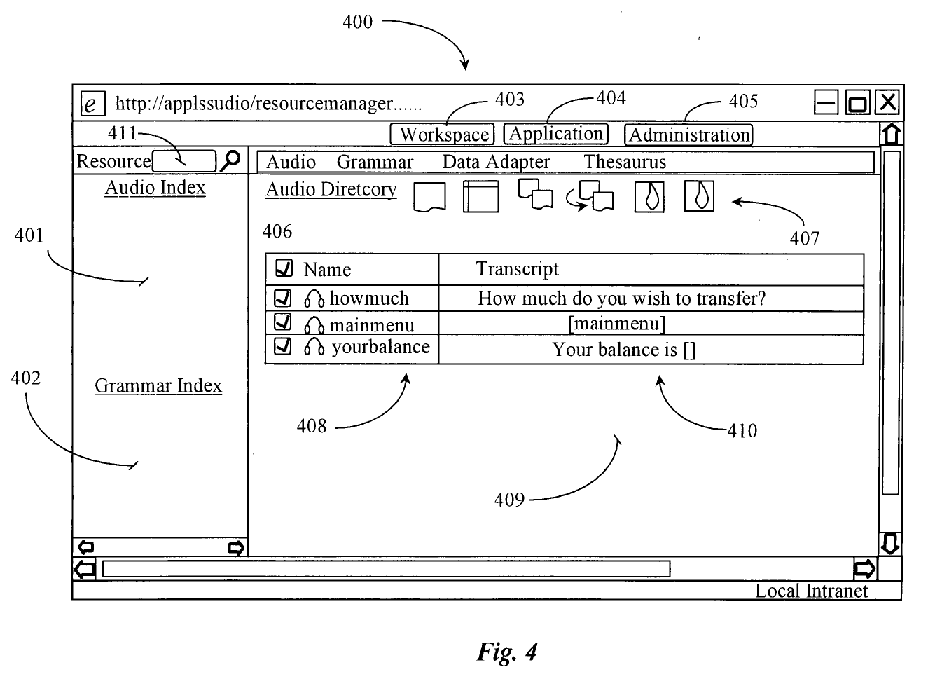

FIG. 4 illustrates an interactive screen 400 for a voice application resource management application according to an embodiment of the present invention. Screen 400 is a GUI portion of a software application that enables a developer to create and manage resources used in voice applications. Resources include both audio resources and application scripts that may be voice synthesized. For this example, the inventor focuses on management of audio resources, which in this case, include voice file or prompt management in the context of one or more voice file applications.

Screen 400 takes the form of a Web browser type interface and can be used to access remote resources over a local area network (LAN), wide area network (WAN), or a metropolitan area network (MAN). In this example, a developer operating through screen 400 is accessing a local Intranet.

Screen 400 has a toolbar link 403 that is labeled workspace. Link 403 is adapted to open, upon invocation, a second window or changes the primary window to provide an area for working and audio management and creation tools for creating and working with audio files and transcripts or scripts.

Screen 400 has a toolbar link 404 that is labeled application. Link 404 is adapted to open, upon invocation, a second window or changes the primary window to provide an area for displaying and working with voice application code and provides audio resource linking capability. Screen 400 also has a toolbar link for enabling an administration view of all activity.

Screen 400 has additional toolbar links 406 adapted for navigating to different windows generally defined by label. Reading from left to right in toolbar options 406, there is Audio, Grammar, Data Adapter, and Thesaurus. The option Audio enables a user to view all audio-related resources. The option Grammar enables a user to view all grammar-related resources. The option Data Adapter enables a user to view all of the available adapters used with data sources, including adapters that might exist between disparate data formats. The option Thesaurus is self-descriptive.

In this example, a developer has accessed the audio resource view, which provides in window 409 an interactive data list 411 of existing audio resources currently available in the system. List 411 is divided into two columns a column 408 labeled “name” and a column 410 labeled “transcript”. In this example there are three illustrated audio prompts reading from top to bottom from list 411 column 408 they are “howmuch”, “mainmenu”, and “yourbalance”. An audio speaker icon next to each list item indicates the item is an audio resource. Each audio resource is associated with the appropriate transcript of the resource as illustrated in column 410. Reading from top to bottom in column 410 for the audio resource “howmuch” the transcript is “How much do you wish to transfer?” For “mainmenu”, the transcript is longer, therefore it in not reproduced in the illustration but may be assumed to be provided in full text. A scroll function may be provided to scroll a long transcript associated with an audio resource. For the audio resource “yourbalance”, the transcript is “Your balance is [ ]. The brackets enclose a variable used in a voice system prompt response to caller input interpreted by the system.

In one embodiment there may be additional options for viewing list 411, for example, separate views of directory 411 may be provided in different languages. In one embodiment, separate views of directory 411 may be provided for the same resources recorded using different voice talents. In the case of voice files that are contextually the same, but are recorded using different voice talents and or languages, those files may be stored together and versioned according to language and talent, or any other criteria.

Window 409 can be scrollable to reach any audio resources not viewable in the immediate screen area. Likewise, in some embodiments a left-side navigation window may be provided that contains both audio resource and grammar resource indexes 401 and 402, respectively, to enable quick navigation through the lists. A resource search function 411 is also provided in this example to enable keyword searching of audio and grammar resources.

Screen 400 has operational connectivity to a data store or stores used to house the audio and grammar resources and, in some cases, the complete voice applications. Management actions initiated through the interface are applied automatically to the resources and voice applications.

A set of icons 407 defines additional interactive options for initiating immediate actions or views. For example, accounting from left to right a first icon enables creation of a new audio resource from a written script. Invocation of this icon brings up audio recording and editing tools that can be used to create new audio voice files and that can be used to edit or version existing audio voice files. A second icon is a recycle bin for deleted audio resources. A third icon in grouping 407 enables an audio resource to be copied. A fourth icon in grouping 407 enables a developer to view a dependency tree, illustrating if, where, and when the audio file is used in one or more voice dialogs. The remaining two icons are upload and download icons enabling the movement of audio resources from local to remote and from remote to local storage devices.

In one embodiment of the present invention, the functions of creating voice files and linking them to voice applications can be coordinated through interface 400 by enabling an author of voice files password protected local or remote access for downloading enterprise scripts and for uploading new voice files to the enterprise voice file database. By marking audio resources in list 410 and invoking the icon 407 adapted to view audio resource dependencies, an operator calls up a next screen illustrating more detail about the resources and further options for editing and management as will be described below.

Screen 400, in this example, has and audio index display area 401 and a grammar display index area 402 strategically located in a left scrollable sub-window of screen 400. As detailed information is viewed for a resource in window 409, the same resource may be highlighted in the associated index 401 or 402 depending on the type of resource listed.

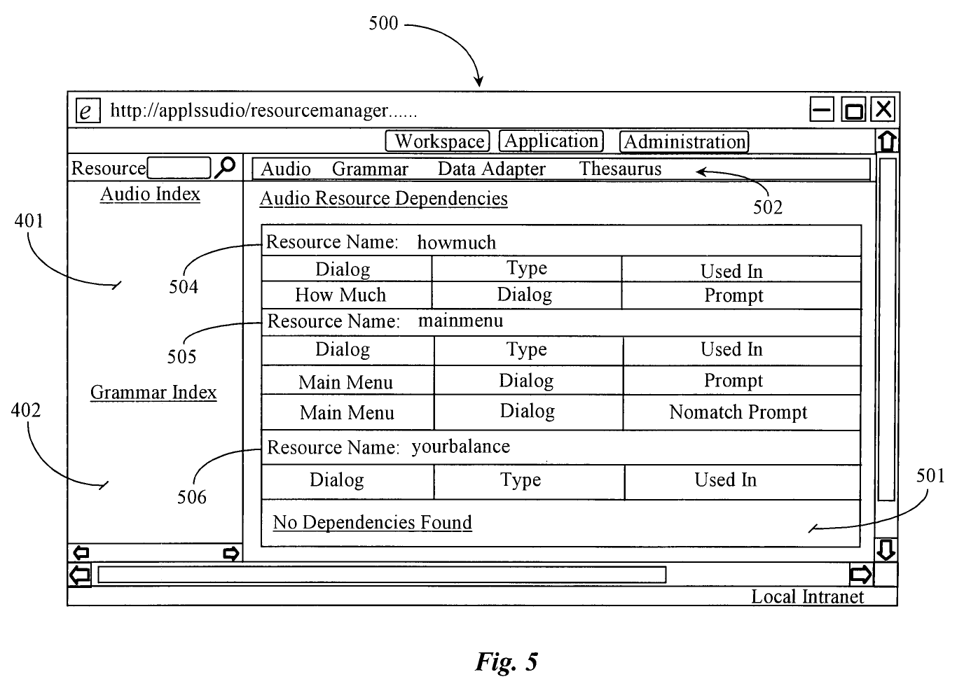

FIG. 5 illustrates an interactive screen 500 showing audio resource details and dependencies according to an embodiment of the present invention. Screen 500 has a scrollable main window 501 that is adapted to display further details about audio resources previously selected for view. Previous options 406 remain displayed in screen 500. In this example each resource selected in screen 400 is displayed in list form. In this view audio resource 504 has a resource name “howmuch”. The resource 504 is categorized according to Dialog, Dialog type, and where the resource is used in existing voice applications. In the case of resource 504, the dialog reference is “How Much”, the resource type is a dialog, and the resource is used in a specified dialog prompt. Only one dependency is listed for audio resource 504, however all dependencies (if more than one) will be listed.

Resource 505, “mainmenu” has dependency to two main menus associated with dialogs. In the first listing the resource is used in a standard prompt used in the first listed dialog of the first listed main menu. In the second row it is illustrated that the same audio resource also is used in a nomatch prompt used in a specified dialog associated with the second listed main menu. For the purpose of this specification a nomatch prompt is one where the system does not have to match any data provided in a response to the prompt. A noinput prompt is one where no input is solicited by the prompt. It is noted herein that for a general application prompt definitions may vary widely according to voice application protocols and constructs used. The dependencies listed for resource 505 may be associated with entirely different voice applications used by the same enterprise. They may also reflect dependency of the resource to two separate menus and dialogs of a same voice application.

No specific ID information is illustrated in this example, but may be assumed to be present. For example, there may be rows and columns added for displaying a URL or URI path to the instance of the resource identified. Project Name, Project ID, Project Date, Recording Status (new vs. recorded) Voice Talent and Audio Format are just some of the detailed information that may be made available in window 501. There may be a row or column added for provision of a general description of the resource including size, file format type, general content, and so on.

Resource 506, “yourbalance” is listed with no dependencies found for the resource. This may be because it is a newly uploaded resource that has not yet been linked to voice application code. It may be that it is a discarded resource that is still physically maintained in a database for possible future use. The lack of information tells the operator that the resource is currently not being used anywhere in the system.

Screen 500, in this example, has audio index display area 401 and a grammar display index area 402 strategically located in a left scrollable sub-window of screen 500, as described with reference to screen 400 of FIG. 4 above. As detailed information is viewed for a resource in window 501, the same resource may be highlighted in the associated index 401 or 402, depending on the type of resource listed.

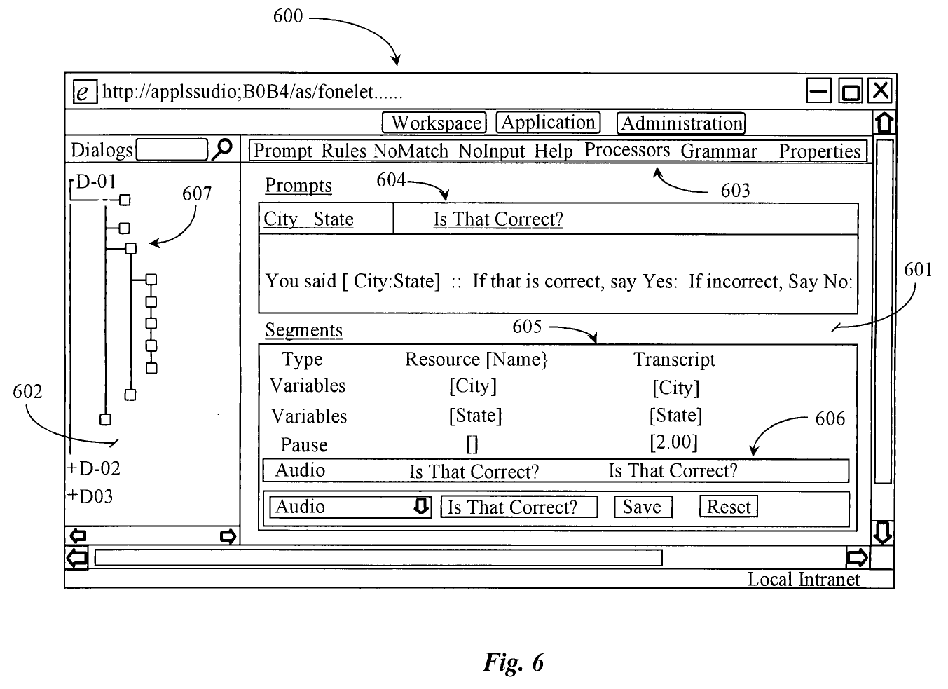

FIG. 6 illustrates an interactive screen 600 of an audio resource manager illustrating further details and options for editing and management, according to an embodiment of the present invention. Screen 600 enables a developer to edit existing voice files and to create new voice files. A dialog tree window 602 is provided and is adapted to list all of the existing prompts and voice files linked to dialogs in voice applications. The information is, in a preferred embodiment, navigable using a convenient directory and file system format. Any voice prompt or audio resource displayed in the main window 601 is highlighted in the tree of window 602.

In one embodiment of the present invention from screen 500 described above, a developer can download a batch of audio resources (files) from a studio remotely, or from local storage and can link those into an existing dialog, or can create a new dialog using the new files. The process, in a preferred embodiment, leverages an existing database program such as MS Excel™ for versioning and keeping track of voice prompts dialogs, sub-dialogs, and other options executed during voice interaction.

In one embodiment of the present invention a developer can navigate using the mapping feature through all of the voice application dialogs, referencing any selected voice files. In a variation of this embodiment the dialogs can be presented in descending or ascending order, according to some specified criteria, such as date, number of use positions, or some other hierarchical specification. In still another embodiment, a developer accessing an audio resource may also have access to any associated reference files like coaching notes, contextual notes, voice talent preferences, language preferences, and pronunciation nuances for different regions.

In a preferred embodiment, using the software of the present invention multiple links do not have to be created to replace an audio resource used in multiple dialog prompts of one or more voice applications. For example, after modifying a single voice file, one click may cause the link to the stored resource to be updated across all instances of the file in all existing applications. In another embodiment where multiple storage sites are used, replication may be ordered such that the modified file is automatically replicated to all of the appropriate storage sites for local access. In this case, the resource linking is updated to each voice application using the file according to the replication location for that application.

Screen 600 illustrates a prompt 604 being developed or modified. The prompt in this example is named “Is that correct?” and has variable input fields of City and State. The prompt 604 combines audio files to recite “You said [City: State]: If that is correct, say Yes: If incorrect, say No.” The prompt may be used in more than one dialog in more than one voice application. The prompt may incorporate more than one individual prerecorded voice file.

A window 605 contains segment information associated with the prompt “Is that correct?” such as the variable City and State and the optional transcripts(actual transcripts of voice files). New voice files and transcripts describing new cities and states may be added and automatically linked to all of the appropriate prompt segments used in all dialogs and applications.

Typically, audio voice files of a same content definition, but prerecorded in one or more different languages and/or voice talents, will be stored as separate versions of the file. However, automated voice translation utilities can be used to translate an English voice file into a Spanish voice file, for example, on the fly as the file is being accessed and utilized in an application. Therefore, in a more advanced embodiment multiple physical prerecorded voice files do not have to be maintained.

Screen 600 has a set of options 603 for viewing, creating or editing prompts, rules, nomatch prompts, and no-input prompts. Options for help, viewing processor details, help with grammar, and properties are also provided within option set 603. Workspace provides input screen or windows for adding new material and changes. The workspace windows can be in the form of an excel worksheet, as previously described.

In one embodiment of the present invention linking voice files to prompts in an application can be managed across multiple servers in a distributed network environment. Voice files, associated transcripts, prompt positions, dialog positions, and application associations are all automatically applied for the editor eliminating prior-art practice of re-linking the new resources in the application code. Other options not illustrated in this example may also be provided without departing from the spirit and scope of the present invention. For example, when a voice file used in several places has been modified, the editor may not want the exact version to be automatically placed in all use instances. In this case, the previous file is retained and the editor simply calls up a list of the use positions and selects only the positions that the new file applies to. The system then applies the new linking for only the selected prompts and dialogs. The old file retains the linking to the appropriate instances where no modification was required.

In another embodiment, voice file replication across distributed storage systems is automated for multiple distributed IVR systems or VXML portals. For example, if a developer makes changes to voice files in one storage facility and links those changes to all known instances of their use at other caller access points, which may be widely distributed, then the distributed instances may automatically order replication of the appropriate audio resources from the first storage facility to all of the other required storage areas. Therefore, for voice applications that are maintained at local caller-access facilities of a large enterprise that rely on local storage of prerecorded files can, after receiving notification of voice file linking to a new file or files can execute an order to retrieve those files from the original storage location and deposit them into their local stores for immediate access. The linking then is used as a road map to insure that all distributed sites using the same applications have access to all of the required files. In this embodiment audio resource editing can be performed at any network address wherein the changes can be automatically applied to all distributed facilities over a WAN.

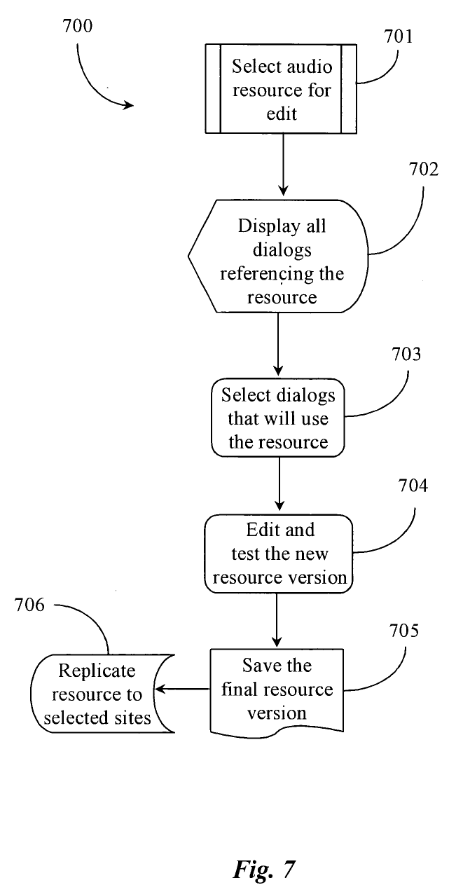

FIG. 7 is a process flow diagram 700 illustrating steps for editing or replacing an existing audio resource and replicating the resource to distributed storage facilities. At step 701, the developer selects an audio resource for editing or replacement. The selection can be based on a search action for a specific audio resource or from navigation through a voice application dialog menu tree.

At step 702 all dialogs that reference the selected audio resource are displayed. At step 703, the developer may select the dialogs that will use the edited or replacement resource by marking or highlighting those listed dialogs. In one embodiment all dialogs may be selected. The exact number of dialogs selected will depend on the enterprise purpose of the edit or replacement.

At step 704, the developer edits and tests the new resource, or creates an entirely new replacement resource. At step 705, the developer saves the final tested version of the resource. At step 706, the version saved is automatically replicated to the appropriate storage locations referenced by the dialogs selected in step 703.

In this exemplary process, steps 702 and 706 represent automated results of the previous actions performed.

The methods and apparatus of the present invention can be applied on a local network using a central or distributed storage system as well as over a WAN using distributed or central storage. Management can be performed locally or remotely, such as by logging onto the Internet or an Intranet, to access the software using password protection and/or other authentication procedures.

The methods and apparatus of the present invention greatly enhance and streamline voice application development, management and deployment and, according to the embodiments described, can be applied over a variety of different network architectures, including DNT and POTS implementations.

One-Touch System Configuration Routine

According to one aspect of the present invention a software routine is provided that is capable of receiving a configuration package and of implementing the package at a point of voice interaction in order to effect system changes and voice application changes without suspending a system or application that is running and in the process of interaction with callers.

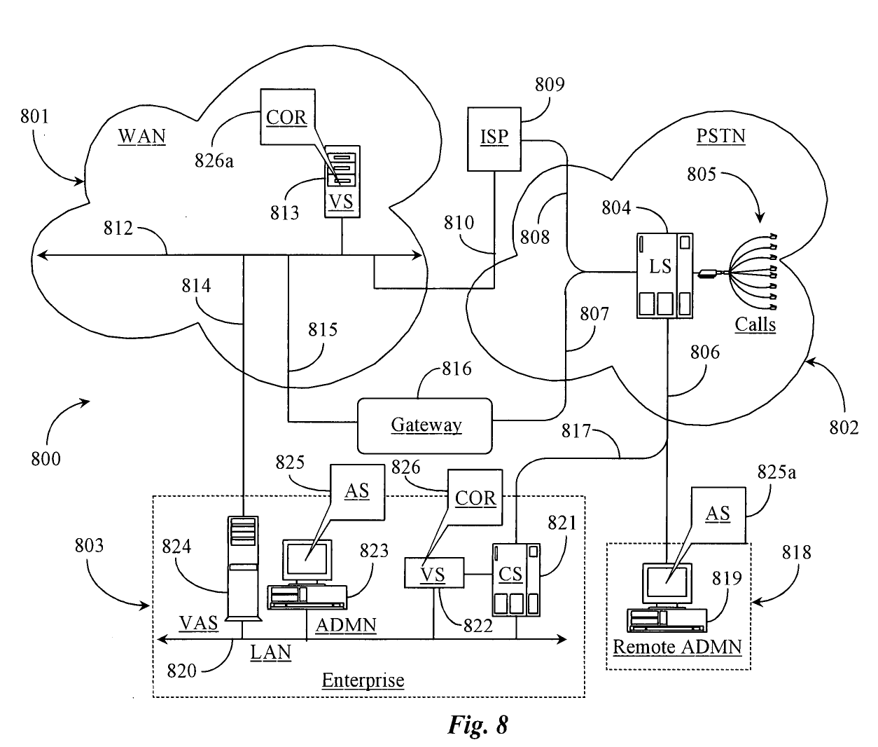

FIG. 8 is architectural overview of a communications network 800 wherein automated voice application system configuration is practiced according to an embodiment of the present invention. Communications network 800 encompasses a WAN 801, a PSTN 802, and a communications host illustrated herein as an enterprise 803.

Enterprise 803 may be any type of enterprise that provides services to callers, which are accessible to a call-in center or department. Enterprise 803, in this example, maintains voice interaction access points to voice services. Enterprise 803 may be assumed to contain a communications-center type environment wherein service agents interact with callers calling into or otherwise contacting the enterprise.

Enterprise 803 has a LAN 820 provided therein and adapted for supporting a plurality of agent-operated workstations for communication and data sharing. LAN 820 has communications access to WAN 801 and to PSTN 802. A central telephony switch (CS) 821 is provided within enterprise 803 and is adapted to receive calls routed thereto from PSTN 802 via a telephony trunk branch 817 from a local switch in the network illustrated herein as switch (LS) 804. LS 804 may be a private-branch type of exchange (PBX), and automated-call-distributor (ACD), or any other type of telephone switch capable of managing telephone calls.

CS 821 has an interactive voice system peripheral (VS) 822 connected thereto by a CTI link. VS 822 also has connection to LAN 820. VS 822 is adapted to interact with callers routed CS 821 according to voice application dialogs therein. VS 822 may be an IVR system or a voice recognition system (VRS) without departing from the spirit and scope of the present invention. VS 822 is a point of deployment for voice applications used for client interaction. In this example, incoming calls routed to CS 821 from LS 800 from within PSTN 802 are illustrated as calls 805 incoming into LS 804 from anywhere within PSTN 805.

Enterprise 803 has a voice application server (VAS) 824 provided therein and connected to LAN 820. VAS 824 is adapted for storing and serving voice applications created by an administrator (ADMN) 823 represented herein by a computer icon also shown connected to LAN 820. ADMN 823 uses a client application software (AS) 825 to create voice applications and manage voice files, voice prompts, and voice dialogs associated with those applications.

Once applications are created they may be deployed by VAS 824 to VS 822 for immediate service. In one embodiment of the present invention, VS 822 stores voice applications locally (storage not shown). In another embodiment of the present invention VS 822 retrieves voice applications from VAS 824 over LAN 820 when those applications are required in interaction with callers. AS 825 installed on workstation 823 is analogous to an application described further above with respect to screenshots 400, 500, and 600 of FIGS. 4, 5, and 6 respectively. One exception is that AS 825 is enhanced, according to an embodiment of the present invention, with a utility for enabling configuration and one touch deployment of voice application or system modification updates to voice applications or settings active at VS 822. In some embodiments of the present invention, updates created and deployed from workstation 823 are applied to voice applications while those applications are active without a requirement for shutting down or suspending those applications from service.

VAS 824, in this embodiment, has connection to WAN 801 via a WAN access line 814. WAN 801 may be the well-known Internet, an Intranet, or a corporate WAN, among other possibilities. LAN access line 814 may be a 24/7 connection or a connection through a network service provider. WAN 801 has a network backbone 812 extending there through, which represents all of the lines, equipment, and access points making up the entire WAN as a whole.

Backbone 812 has a voice system peripheral (VS) 813 connected thereto, which represents a data-network-telephony (DNT) version of VS 822. VS 813 uses voice applications to interact with clients accessing the system from anywhere in WAN 801 or any connected sub networks. It is noted herein, that networks 802 and 801 are bridged to gather for communication via a gateway 816. Gateway 816 is adapted translating telephony protocols into data network protocols and in reverse order enabling, for example, IP telephony callers to place calls to PSTN destinations, and PSTN telephony callers to place calls to WAN destinations. In one embodiment, gateway 816 may be an SS-7 Bell core system, or some other like system. Therefore, it is possible for PSTN callers to access voice interaction provided by VS 813 and for WAN callers to access voice interaction provided by VS 822.

A remote administrator is illustrated in this example as a remote ADMN 818. ADMN 818 may be operating from a remote office, from a home, or from any physical location providing telephone and network-access services. A personal computer icon representing a workstation 819 further defines ADMN 818. Workstation 819 is analogous in this embodiment to workstation 823 except that it is a remote workstation and not LAN-connected in this example.

Workstation 819 has a software application 825a provided thereto, which is analogous to application 825 installed on workstation 823 within enterprise 803. Voice systems 822 and 813 have instances of a configuration order routine (COR) 826 for VS 822, and 826a for VS 813, installed thereon. COR (826, 826a) is adapted to accept a configuration order package from AS 825 and/or AS 825a, respectively. COR (826, 826a) accepts and implements configuration orders created by ADMNs 823 or 819 and automatically applies those configuration orders to their respective voice systems.

In a preferred embodiment of the present invention, ADMN 823 utilizes AS 825 to create necessary updates to existing voice applications including any required settings changes. Voice application sender 824 contains the actual voice applications in this case, which may be served to VS 822 when required. In one embodiment however, voice VS 822 may store voice applications for immediate access. After making the required edits, ADMN 823 may initiate a one-touch deployment action that causes a change-order to be implemented by COR 826 running in VS 822. It is noted herein that a change-order for a voice application that is running may automatically extract and implement itself while the application is still running. A change-order may also be implemented to an application that is not currently running without departing from the spirit and scope of the present invention.

When VS 822 receives a change-order from ADMN 823, COR 826 executes and implements the change-order. In the case of a running application, there may be a plurality of callers queued for different dialog prompts or prompt sequences of the same application. In this case, COR 826 monitors the state of the running application and implements the changes so that they do not negatively affect caller interaction with the application. More detail about how this is accomplished is provided later in this specification.

Remote ADMN 819 may also create and implement change-orders to applications running in VS 822 from a remote location. For example, utilizing AS 825a, ADMN 819 may connect to ISP 809 through LS 804 via trunk 806 and trunk branch 808. ISP 809 may then connect ADMN 819 to backbone 812, from which VS 824 is accessible via network line 814. ADMN 819 may therefore perform any of the types of edits or changes to applications running in VS 822 or to any settings of VS 822 that ADMN 823 could configure for the same. Moreover, ADMNs 823 and 819 may generate updates for any voice applications running on VS 813 connected to backbone 812 in WAN 801.

Calls 805 may represent PSTN callers accessing CS 821 through trunk 806 and trunk branch 817. Calls 805 may also include callers operating computers accessing VS 813 through ISP 809 via trunk branch 808 and network line 810, or through gateway 816 via trunk branch 807 and network line 815. Although the architecture in this example illustrates tethered access, callers 805 may also represent wireless users.

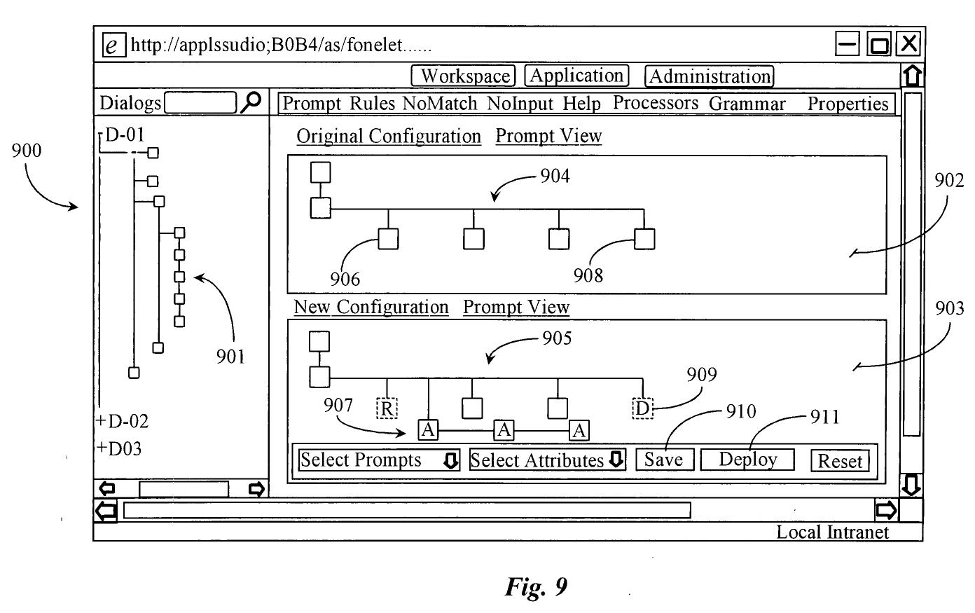

FIG. 9 is an exemplary interactive screen 900 illustrating application of modifications to a voice dialog according to an embodiment of the present invention. Screen 900 illustrates capability for creating a change-order or update to voice application dialog in this example. Screen 900 is a functional part of AS 825 or 825a described above with reference to FIG. 8. Screenshot 900, in a preferred embodiment, stems from the same parent application hosting interactive screens 400, 500, and 600, described above.

Interactive screen 900 contains a workspace 902, and a workspace 903. Space 902 contains a portion 904 of a dialog D-01 (logical representation only) illustrated in expanded view as a dialog 901, which is accessible from a dialog menu illustrated at far left of screen 900. A dialog search box is provided for locating any particular dialog that needs to be updated.

Within workspace 902, dialog portion 904 is illustrated in the form of an original configuration. In this example, a prompt 906 and a prompt 908 of dialog portion 904 will be affected by an update. Dialog portion 900 is illustrated within workspace 903 as an edited version 905. Workspace 903 is a new configuration workspace.

Prompt 906 in workspace 902 is to be replaced. In workspace 903, the affected prompt is illustrated as a dotted rectangle containing an R signifying replacement. In this example, prompt 906 is replaced with a prompt sequence 907. Sequence 907 contains three prompts labeled A signifying addition. Prompt 908 from workspace 902 is illustrated as a deleted prompt 909 in workspace 903 (dotted rectangle D).

The new configuration 905 can be “saved-to-file” by activating a save button 910, or can be saved and deployed by activating a deploy button 911. A reset button is also provided for resetting new configuration 905 to the form of the original configuration 904. Interactive options for selecting prompts and for selecting attributes are provided for locating the appropriate new files linked to the dialog. Each workspace 902 and 903 has a prompt-view option enabling an administrator to select any prompt in the tree and expand that prompt for play-back purposes or for viewing transcripts, author data, and so on.

When an original configuration has been updated to reflect a new configuration, selecting the deploy option 911 causes the update package to be deployed to the appropriate VS system (if stored therein) or to the VAS if the application is executed from such a server. The exact point of access for any voice system will depend on the purpose and design of the system. For example, referring back to FIG. 8, if a voice system and switch are provided locally within an enterprise, then the actual voice applications may be served to callers through the voice system, the application hosted on a separate machine, but called in to service when needed. In one embodiment, VS 824 distributes the voice applications to the respective interaction points or hosts, especially if the interaction host machine is remote.

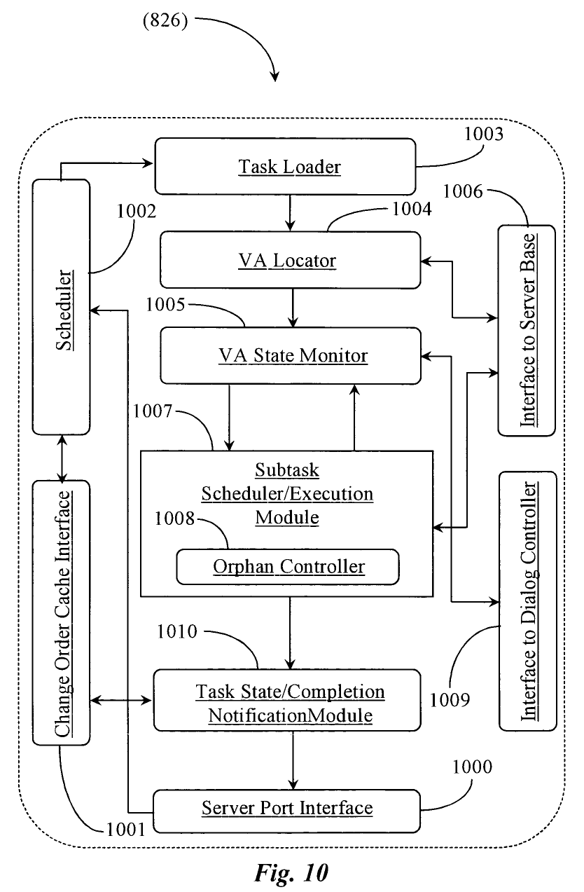

FIG. 10 is a block diagram illustrating components of automated voice application configuration routine (826, 826a) according to an embodiment of the present invention. Application 826 contains several components that enable automated configuration of updates or edits to voice applications that may be in the process of assisting callers.

Application 826 has a server port interface 1000 adapted to enable the application to detect when a change-order or update has arrived at the voice system. A host machine running application 826, in a preferred embodiment, will have a cache memory or data queue adapted to contain incoming updates to voice applications, some of which may be running when the updates have arrived.

Application 826 has a scheduler component provided therein and adapted to receive change-orders from a cache memory and schedule those change-orders for task loading. It is noted herein that a change-order may have its own schedule for task loading. In this case, scheduler 1002 parses the schedule of the change-order and will not load the order until the correct time has arrived. Application 826 has a task loader 1003 provided therein and adapted to accept change-orders from scheduler 1002 for immediate implementation.

In one embodiment of the present invention, application 826 receives change-orders that include both instructions and the actual files required to complete the edits. In another embodiment of the present invention application 826 receives only the instructions, perhaps in the form of an object map or bitmap image, wherein the actual files are preloaded in identifiable fashion into a database containing the original files of the voice application or voice system settings. For updating voice applications, the actual implementation will depend on whether the voice files used to update the application are stored locally (within the VS) or are accessed from a separate machine, such as a VAS.

Application 826 has a voice application (VA) locator 1004 provided therein, and adapted to find, in the case of a voice application update, the correct application that will be updated. It is possible that the application being updated is not in use currently. It is also possible that the application being updated is currently in use. In either instance, VA locator 1004 is responsible for finding the location of the application and its base files.

VA locator 1004 has connection to a database or server base interface 1006 provided therein and adapted to enable VA locator 1004 to communicate externally from the host system or VS. Therefore, if a particular voice application is being stored on a voice application server separate from the voice system that uses the interaction, the voice application locator running on the voice system can locate the correct application on the external machine.

Application 826 has a voice application (VA) state monitor 1005 provided therein and adapted to monitor state of any voice application identified by VA locator 1004 that is currently running and serving callers during the time of update. State monitor 1005 has connection to a dialog controller interface 1009. A dialog controller is used by the voice system to execute a voice application. The dialog controller manages the caller access and dialog flow of any voice application in use by the system and therefore has state information regarding the number of callers interacting with the application and their positions in the dialog hierarchy.

Application 826 has a sub-task scheduler/execution module 1007 provided therein, and adapted to execute a change-order task according to instructions provided by VA state monitor 1005. Module 1007 contains an orphan controller 1008. Orphan controller 1008 is adapted to maintain a functioning state in a voice application of certain prompts or prompt sequences that are to be deleted or replaced with new files used by a new configuration.

It is important that the current caller load using the voice application under modification is not inconvenienced in any way during the flow of the application and that callers traversing a new dialog will have the prompts in place so that the application does not crash. For this reason, orphans are maintained from the top down while changes to the application are built from the bottom up. In one embodiment of the present invention a new configuration is an object tree wherein the objects are prompts and prompt sequences. Similarly, the voice application that is to be modified has a similar object tree. The objects or nodes are links to the actual files that are applied in the voice interaction. Likewise, there are objects or nodes in a voice application tree that represent functional code responsible for the direction of the application determined according to user response.

Module 1007 cooperates with VA state monitor 1005 to perform a change-order to a voice application using orphan controller 1008 to maintain functional orphans until all of the new objects are in place and callers are cleared from the orphan tree. In actual practice, the voice application being modified continues to function as a backup application while it is being modified. Replacement files and code modules associated with the change-order are, in a preferred embodiment, available in the same data store and memory partition that the original application files and code reside having been loaded therein either from cache or directly. In one embodiment, the files representing changes may be preloaded into the same storage system that is hosting the old files, such that as a change-order is implemented by application 826 the change files are caused to take the place of the original files, as required. The subtask scheduler portion of module 1007 works with VA state monitor 1005, which in turn has connection to the application dialog controller, which in turn has connection to the telephony hardware facilitating caller connection to voice applications. Therefore, module 1007 can apply changes to the application and maintain orphan state until all of the accessing callers are interacting with the new configuration in a seamless matter. At that point the orphans (old files and settings) may be purged from the system.

Application 826 has a task state/completion notification module 1010 provided therein and adapted to send notification of the completed task to the task author or administrator through server port interface 1000. Module 1010 also has connection to change-order cache interface 1001 for the purpose of purging the cache of any data associated with a task that has been completed successfully.

In one embodiment of the present invention, module 1010 may send, through interface 1000, an error notification or an advisory notification related to a change-order task that for some reason has not loaded successfully or that cannot be implemented efficiently. In the latter case, it may be that due to an unusually heavy call load using an existing application a change-order may be better scheduled during a time when there are not as many callers accessing the system. However, this is not required in practice the present invention as during change-order implementation, nodes are treated individually in terms of caller access and as long as the new changes are implemented from the bottom up callers may be transferred from an orphan, for example, to a new object in a dialog tree until such time that that orphan may be replaced or deleted and so on.

Application 826 may be provided as a software application or routine that takes instructions directly from the change-orders it receives. In one embodiment of the present invention application 826 may be provided to run on a piece of dedicated hardware as firmware, the hardware having connection to the voice system. There are many possible variant architecture designs that may be used without departing from the spirit and scope of the present invention.

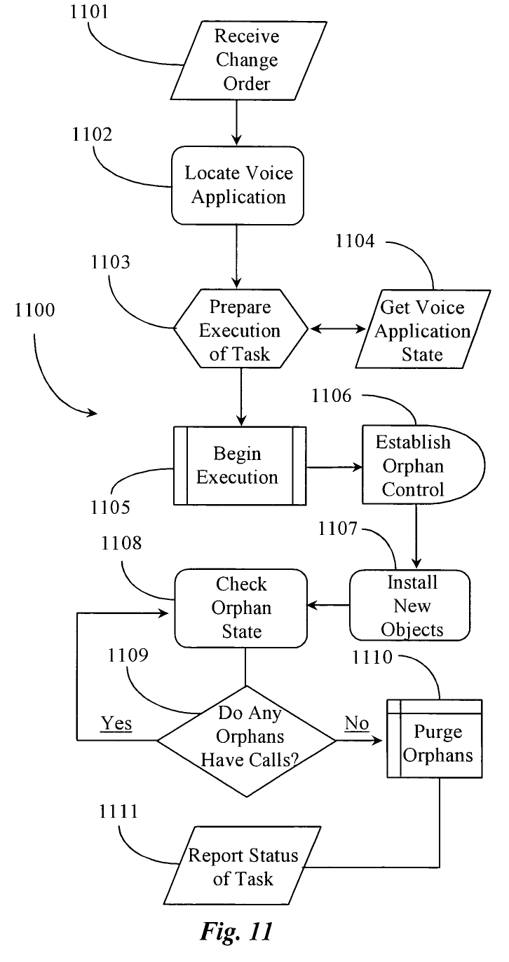

FIG. 11 is a process flow chart 1100 that illustrates the steps associated with receiving and implementing a change, according to an embodiment of the present invention. At step 1101, a change-order is received by the system. In step 1101, the actual files of the change-order may be cached in a cache memory and the change-order instructions, which in one embodiment are of the form of an executable bitmap or object model, are loaded into a task loader analogous to loader 1003 of FIG. 10 for processing.

At step 1102, the system locates the voice application that is the target of the change-order. In one embodiment of the present invention, the target voice application may not be in current use. In this case, the changes may be implemented without concern for the active state of any interaction with callers. In another embodiment, the target voice application may be currently in use with one or more of callers interacting with it. Assuming the latter case at step 1103, the system prepares for execution of the change implementation task. At step 1104, the current running state of the voice application is acquired. This information may include the total number of callers currently interacting with the application and their current positions of interaction with the application. Step 1104 is an ongoing step, meaning that the system constantly receives the then current application state with respect to the number of callers and the caller positions in the dialog flow of the application.

At step 1105, execution of the change-order begins. At step 1106, any orphans in the old application are identified and maintained from the top or root node of the application down the hierarchy until they are idle or not in a current state of access from one or more clients. At step 1107, any new objects being applied to the application are built into the application from the bottom up toward the root node of the application. In step 1106, orphan control is established with respect to all of the components of the application that will be replaced or modified. Establishing orphan control involves identifying the components of the application that will be deleted, replaced, or modified, and establishing an orphan state of those components. The orphan state enables clients that are already queued for interaction with those components to traverse those components in a seamless manner.

At step 1108, the state of each orphan established in the target voice application is continually checked for an opportunity to purge the orphan and allow anew object to take over that position in the dialog. At step 1109, it is decided whether those orphans checked have any callers interacting with them. At step 1110, if an orphan has callers interacting with it, then the process reverts back to step 1108 for that orphan. All established orphans might, in one embodiment, be monitored simultaneously. At step 1108, if an orphan does not have calls interacting with it, then at step 1109 that orphan may be purged if the new component associated therewith is already in place to take over from the orphan as a result of step 1107.

In one embodiment of the present invention, a change is implemented only when a last maintained orphan of a tree is free of calls. Then the next orphan up is continually monitored in step 1108 until it is free of calls. In one embodiment; however, if a change-order is only to modify certain content or style of one or more voice prompts of an application but does not change the intent or direction of the interaction flow with respect to caller position, then any orphan in the tree may be purged at step 1110 when it is not in a current interaction state. At step 1110, a new object associated with an orphan immediately takes over when an orphan is purged. If an orphan has no replacement node it is simply purged when it is not currently in use.

In a preferred embodiment of the present invention at steps 1106 and 1107, the code portion of the new configuration provides all of the required linking functionality for establishing transient or temporary linking orders from prompt to prompt in a dialog. Therefore, an orphan that is still in use, for example, may be temporarily linked to a new node added further down the dialog tree. When that orphan is purged, a new object (if in place) takes over the responsibilities of caller interaction and linking to further objects. At step 1111, the system reports status of task implementation.

In one embodiment of the present invention, files are actually swapped from cache to permanent storage during configuration. For example, a new component may not be inserted into the voice application until the final orphan being maintained in the tree is cleared of callers for a sufficient amount of time to make the change over and load the actual file or files representing the new object. The next orphan above a newly inserted object may be automatically linked to the new component so that existing callers interacting with that orphan can seamlessly traverse to the new component in the application enabling lower orphan nodes to be purged. This process may evolve up the tree of the voice application until all of the new objects are implemented and all of the orphans are purged.

In a preferred application of the present invention, new objects are installed immediately after orphans are established at step 1106. In this embodiment, the new objects are installed side-by-side with the established orphans except in the case where an orphan is deleted with no modification or replacement plan. In this case, the new components are selected to immediately take over during a lull in interaction when there are currently no callers interacting with that portion of the tree. New objects may also be added that do not replace or conflict with any existing files of a voice application. In this case no orphan control is required. Code and linking instruction in a new configuration is applied to the old configuration in the same manner as voice file prompts.

In one embodiment, transitory links are established in a new configuration for the purpose of maintaining application dialog flow while new objects are installed. For example, two links, one to an orphan and one to the new component may be provided to an existing component that will be affected. If an orphan has current callers but the node below it has none, the orphan can automatically link to the new object even though it is still being used.

One with skill in the art will recognize that the process order of flowchart 1100 may vary according to the type of implementation. For example, if a change-order includes the physical voice files and code replacements and those are handled by the application, then at step 1107 installing new objects may include additional subroutines that move the objects from cache memory to permanent or semi-permanent storage. If the physical voice files and code replacements are preloaded into a database and then accessed during the configuration implementation, then step 1107 may proceed regardless of orphan status, however the new components are activated only according to orphan status.

The method and apparatus of the present invention can be implemented within or on a LAN, or from a remote point of access to a WAN, including the Internet, without departing from the spirit and scope of the present invention. The software of the present invention can be adapted to any type of voice portal that users may interact with and that plays voice files according to a pre-determined order.

Dynamic Ad Presentation

According to one embodiment of the present invention, the inventor provides a method and system for dynamically selecting and, in some cases, dynamically creating and presenting voice dialogs, which may be commercial advertisements or other information messages, to callers of a voice-based interaction system. For the purpose of better understanding the following explanation of the present invention, the term voice dialog shall be referred to herein as advertisement, or ad, or information message. Likewise the term caller shall be synonymous with user, client, and customer when used in the same pretext. The methods and system of the present invention will be described in enabling detail below.

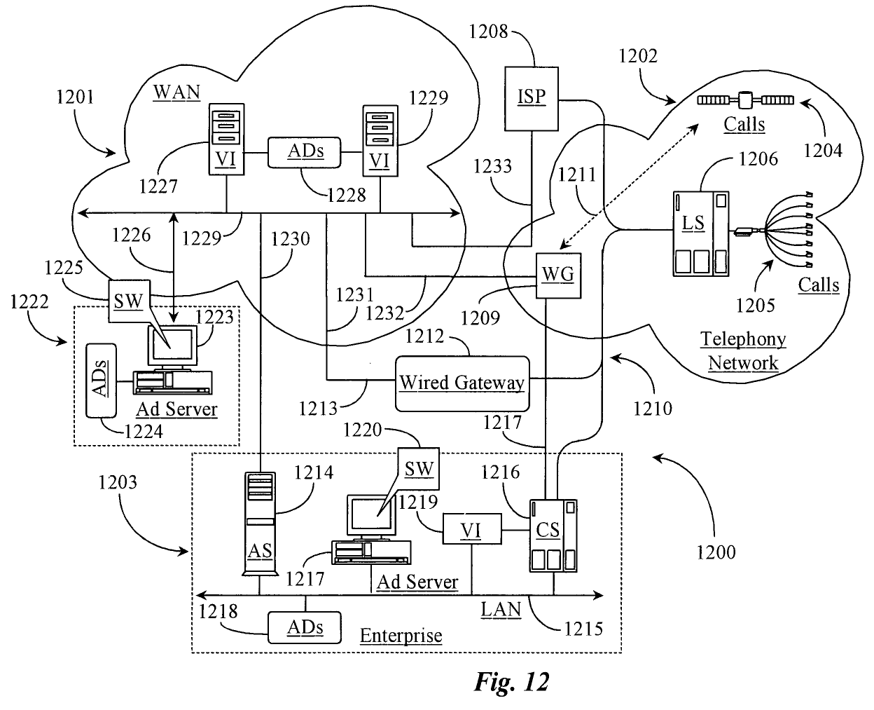

FIG. 12 is an architectural overview 1200 of a communication network wherein dynamic ad selection and delivery is practiced according to an embodiment of the present invention. Architecture 1200 encompasses a wide-area-network (WAN) 1201, a telephony network (TN) 1202, and a business enterprise 1203 having connection to both networks.

Architecture 1200 is very similar in network and connection attributes to architecture 800 described with respect to FIG. 8 above; however, the illustration is modified somewhat to explain the present invention. Therefore, each element illustrated in FIG. 12 that is also found in FIG. 8 shall be given a new element number and shall be newly introduced.

WAN 1201 is, in a preferred embodiment, the well-known Internet, but may also (in other embodiments), be another type of WAN, such as an Intranet network, a corporate network, a LAN, a sub-WAN to the Internet, or even a wireless MAN. In this example, WAN 1201 may be referred to herein as Internet 1201. WAN 1201 has an Internet backbone 1229 extending there through. Internet backbone 1229 is illustrated to represent all of the network lines, equipment and access points that make up the Internet as a whole. Therefore, there are no geographic limitations to the practice of the present invention.

TN 1202, in a preferred embodiment, is a PSTN. TN 1202 may also, in other embodiments, be a private telephony or data network or a wireless cellular data network.

Enterprise 1203 may be any type of business that has a client base, such as a sales and service organization. In one embodiment, enterprise 1203 may be a third-party service provider adapted to provide voice application services and infrastructure to other organizations. In a preferred embodiment, enterprise 1203 leverages WAN 1201 and TN 1202 to provide voice application services, and in some embodiments, sales and service to customers who are contacting enterprise 1203 through WAN 1201 and/or TN 1202.

TN 1202 has a local telephony switch (LS) 1206 illustrated therein and adapted to route and to otherwise process incoming calls represented in this example as calls 1205. Calls 1205 are typically customers of enterprise 1203 attempting to access the enterprise to engage in business with the enterprise. LS 1206 may be a private branch exchange (PBX), an automatic call distributor (ACD) or another type of telephony call-routing and processing utility.

TN 1204 has a wireless satellite or cellular tower 1204 illustrated therein and adapted, in a wireless embodiment, to enable calls placed to destinations through a wireless gateway (WG) 1209. Wireless calls are represented herein by a wireless link 1211 between satellite 1204 and WG 1209. Calls from anywhere in the PSTN or other connected networks may be routed through LS 1206 to enterprise 1203, more particularly, to a central office telephony switch (CS) 1216 illustrated within enterprise 1203 via telephony trunk 1210. Calls may also be routed to Internet 1201 through an Internet service provider (ISP) 1208, or through a wired gateway illustrated herein as gateway 1212 via trunk 1210. Wireless callers calling from a wireless network may access Internet 1201 through WG 1209 as described above in a wireless embodiment. Wireless calls 1204 may also reach or be routed to CS 1216 through WG 1209 and over trunk 1217.

Enterprise 1203 has a LAN 1215 provided therein and adapted to support various nodes for communication and to support external network protocols. If enterprise 1203 is a sales and service organization, LAN 1215 may support a plurality of computer work stations manned by enterprise personnel, and adapted to aid in the provision of customer service. CS 1216 is adapted to route telephone calls to various enterprise stations (telephones and/or computer lo monitors) by way of internal telephone or other connection (not illustrated).

In this example, enterprise 1203 is enhanced with a capability of authoring voice applications, which may be VXML-enabled, and deploying those voice applications to execute on a voice interface, illustrated herein as a voice interface (VI) 1219 having connection to CS 1216. Voice interface 1219 is a processor running software that is programmed to interact with customers using voice recognition, synthesized voice from text and/or pre-recorded voice prompts and dialogs. Voice applications are created and maintained in an application server (AS) 1214, which is connected to LAN 1215.

Audio and text resources used by voice applications may be stored locally in AS server 1214, or in VI 1219, or in a suitable repository (not illustrated) connected to LAN 1215. In one embodiment, text and audio resources may be stored externally from LAN 1215, but accessible via hyperlink. For example, certain resources may be maintained on an external network such as Internet 1201. Voice applications may be authored and tested using any of a number of computer stations assumed to be connected to LAN 1215, such station or stations hosting the appropriate software.

In a typical localized application, when callers reach CS 1216, VI 1219 interacts with those callers in an automated fashion to determine call purpose and to fulfill the caller's business goals. For example, VI 1219 may present a voice application comprising a main greeting and menu option dialog wherein callers may voice desired options to navigate the automated system. Callers may submit orders for products or services, pay bills, and perform many other business tasks with enterprise 1203 without requiring the interaction of a live agent.

The architecture of one or more voice applications enables the automated system to accomplish enterprise goals. It has occurred to the inventor that one logical enterprise goal is to inform callers about special sales, promotions, new products, informational programs, or any other desired messaging, and to enable those callers to complete tasks automatically through interaction with VI 1219. Moreover, enterprise 1203 may wish to provide third-party solicited advertising to those callers, or internal service or product messaging to those callers in a way that provides some flexibility in ad selection in accordance with the individual caller's behavioral traits during the interaction, and/or according to what may be known about a caller by the enterprise.

Static advertising, such as offering the same service promotion to every caller in a voice application greeting, lacks flexibility. One goal of the present invention is to be able to dynamically select either pre-built or dynamically generated advertisement-related dialogs or prompts from a pool of such content, based on either known information about the caller or the decisions of the caller within the interactive environment. Therefore, the inventor provides an ad server 1217 for dynamically serving pre-built or dynamically generated ads to callers based on either previously known caller information about the caller and/ or the caller's behavioral traits observed by the system.

Ad server 1217 may be a computer connected to LAN 1215, as is illustrated in this example, or it may be a server node, or simply a piece of software running on a suitable node that is adapted to select and serve advertisements for inclusion into and execution within voice applications running on VI 1219. In a preferred embodiment, a pool of pre-built ad prompts or voice dialogs are maintained in an ad repository 1218 connected to LAN 1215. In another embodiment of the current invention, specific ad prompts or dialogs may be dynamically created on-the-fly by the system and then maintained in the ad repository 1218 to be available for selection and serving to any current or future caller. Repository 1218 is adapted to contain ads that may be automatically selected and dynamically served to VI 1219 for execution and subsequent interaction with clients of enterprise 1203, whether that ad had been previously built or has been dynamically built during the interaction with the client.

Ad server 1217 has an instance of software (SW) 1220 provided thereon and executable there from. SW 1220 is adapted in one embodiment, to enable the dynamic creation of ad dialogs and of serving or delivering those dynamically created dialogs to a running voice application for implementation. In another embodiment, SW 1220 is not used to create ads, but rather to locate and serve those ads created by another machine or at another station. In this example, pre-created ad dialog is stored in an ads repository 1218 and is retrieved when selected by the system for deployment to VI 1219 and the currently running voice application.

In this example, AS 1214 has access to VI 1219 over LAN 1215. AS 1214 also has a direct Internet connection to Internet backbone 1229 through a network-access data line 1230. Enterprise 1203 may host other voice interfaces besides VI 1219. A VI 1227 and a VI 1229 are illustrated as provided within Internet 1201 and connected to backbone 1229 for network access. Enterprise 1203 may host one or both VI servers 1227 and 1229. In this regard VI 1227 and VI 1229 are Web-servers that utilize TTS and VRS to interact with callers in the same general way as VI 1219. Therefore, a caller that has a destination number of enterprise 1203 may be first routed to either VI 1227 or VI 1229 for interaction.

Enterprise 1203 may, through Internet access line 1230, maintain ads, text, and audio resources on a server or node connected to backbone 1229. Enterprise 1203 may also through the same means, create and deploy voice applications to be executed in VI 1227 and in VI 1229. Likewise, dynamic advertisements may be maintained in a repository accessible to both VI 1227 and VI 1229, as is the case in this example with ad repository 1228.

Ad repository 1228 may be part of either VI 1227 or VI 1229, or it may be separate from them, without departing from the spirit and scope of the present invention. Similarly, ad repository 1218 on LAN 1215 may be internal to AS 1214, to ad server 1217, or may be internal to VI 1219 without departing from the spirit and scope of the present invention. Moreover voice interfaces 1219, 1227, and 1229 may all share one or more ad repositories or it they access one or more other servers that support a software program that dynamically creates such ad dialogs and prompts. The inventor illustrated separate ad repositories for the purpose of clarity only in a logical representation.

In addition to enterprise 1203, a third-party ad provider 1222 is illustrated in this example and has connection to Internet backbone 1229 via a network access line 1226. Ad provider 1222 may be any third-party enterprise that does not create voice applications, but may create advertisement content that may be used in deployed voice applications. Ad provider 1222 has an ad server 1223 provided therein running software (SW) 1225. Server 1223 and SW 1225 are analogous in description to server 1217 and SW 1220 except that third-party software preferably and by default may also be used to create advertisements that are ultimately routed into the voice interaction environment.

Ad server 1223 has an ad repository 1224 connected thereto and adapted to contain ad dialogs and prompts, which may be served to a running voice application deployed in either VI 1227 or in VI 1229. It is noted herein that ad dialogs and prompts may be stored with default voice application dialogs and prompts without departing from the spirit and scope of the present invention. In a preferred embodiment all audio and text resources, whether previously built or dynamically created, are linked to each voice application wherein they are used.

When voice applications are created the audio and text resources used to interact with callers are referenced and linked into the voice application script. When a voice application is running and callers are interacting with the script, resources are retrieved and played according to interaction rules, including caller responses, recognized by the system. In systems known to the inventor, the voice application script references a single or sequence of audio resources that are pre-recorded, or text resources that will be voice synthesized at the appropriate insert points during caller interaction with the application, including those resources referenced according to caller interaction response. Therefore, in systems known to the inventor, any advertisements referenced are either (1) static advertisements or (2) dynamically created advertisements that are retrieved and played at points in the voice application programming script.

In order to retrieve and present advertisements that are selected or dynamically created based on information known or observed about a user, the voice application script references a plurality of dialog objects or resources rather than just one resource. SW 1220 has a resource-selection algorithm provided therein that is adapted to select from a pool of ad dialogs or prompts referenced as a collection of multiple dialog objects by the voice application script. The selection mechanism makes a selection based on information that is known to the system at the time of the selection, such data about the caller; including profile data, other pre-known data, and data acquired through analysis of the caller's behavior during the caller's interaction with the enterprise.

In one embodiment of the present invention, data about a caller is analyzed and given specific values whereupon those values are compared via algorithm against at least one rule. The rule or rules consulted contain the identification and location of the ad objects in the referenced pool and the selection is based on the result of comparison against the rules. There are many differing schemas that may be applied without departing from the spirit and scope of the present invention. The exact schema implemented may also depend on the type of data accepted for analyzing.

In practice of the present invention, a caller connects to a voice interface (VI), such as VI 1219 via trunk 1210, and CS 1216. A voice application running on VI 1219 begins interaction with the caller. Ad server 1217 monitors the interaction progress and waits until an ad insertion point in the interaction is reached. An ad insertion point may be programmed anywhere in a voice application script and there may be more than one ad insertion point per voice application. In one embodiment, SW 1220 is integrated with the voice interface.

At a point where an ad may be selected, retrieved, and presented to a caller, SW 1220 analyzes caller data against a set of rules and if the rules determine that an ad is to be inserted, then SW1220 either selects an ad dialog from the pool based on the data or creates the ad based on the triggered business rule and the information provided about the caller. At this point, the ad dialog plays as an integrated part of the voice application. SW 1220 has intimate information about the script of the voice application and has access to enterprise rules regarding ad selection.

Third-party provider 1222 may use ad server 1223 running SW 1225 to select and insert ad dialogs and prompts into voice applications running on interface 1227 or interface 1229. In this case, provider 1222 may create ads for enterprise 1203. When enterprise 1203 creates voice applications, the scripts of those applications may reference certain ad-dialog-object pools created and maintained in ad repository 1224. That is to say an ad insertion point in the script may reference a remote resource that is part of an ad pool or an ad creation server. Ad server 1223, being remote from a VI interface, monitors the interface and executes SW 1225 at the appropriate points for ad insertion.

SW instances 1220 and 1225 are spawned for each instance of an interacting caller connected to a running voice application at a voice interface for which it has been determined to dynamically serve a pre-built or dynamically created ad. Therefore, each instance has access to caller data about the caller that it may select and serve ads to. Each instance also has access to at least one ad dialog object pool and a set of rules governing ad insertion. SW 1220 and 1225 may be likened to a voice application script extension that creates a temporary link in the voice application script to a selected audio or text resource, which in this case is an advertisement.

One with skill in the art of voice application services will recognize that dynamic advertisements may be maintained as pre-recorded prompts and dialogs or as test dialogs that are voice synthesized during interaction using VXML, VRS and TTS technologies without departing from the spirit and scope of the present invention. In a preferred embodiment, the present invention is used in a VXML environment.

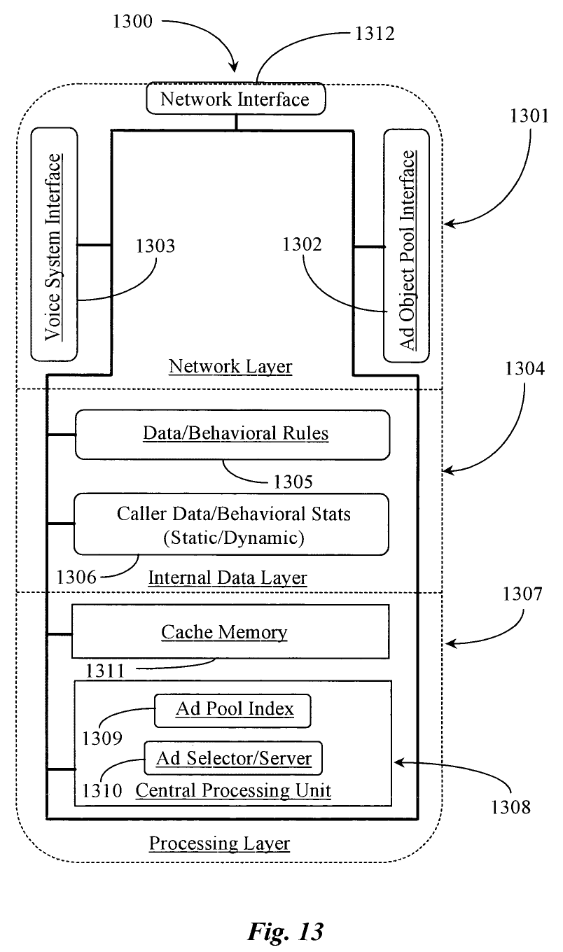

FIG. 13 is a block diagram 1300 illustrating components of a dynamic ad server according to an embodiment of the present invention. Ad server 1300 is analogous to SW 1220 and 1225 described in FIG. 12. Servers 1217 and 1223 represent a base hardware platform from which to execute ad server 1300 and are not specifically required in the illustrated form for successful practice of the invention. For example, ad server 1300 may reside on a voice interface processor, a network server, or on another network-capable node. Ad server 1300 has at least three basic functional software layers. There is a network layer 1301, an internal data layer 1304, and a processing layer 1307. Ad server 1300 may operate remotely from a voice interface in one embodiment. In this case, ad server 1300 may have a voice system interface 1303 provided therein and adapted to enable bi-directional communication between server 1300 and a voice interface system charged adapted for caller interaction using a voice application.

In another embodiment where ad server 1300 is provided within a voice interface system, then interface 1303 may be an internal connection. In a preferred embodiment, interface 1303 enables ad server 1300 to monitor the progress of users accessing a voice application at a particular interface. Caller identification and caller behavioral data may be passed to ad server 1300 through interface 1303 in real time. Ad server 1300 may also have a normal network interface 1312 for enabling remote software upgrades, updates to ad-server rules, static caller data updates, and the like.

Ad server 1300 uses all of the available network ports and protocols enabled on the host node. Ad server 1300 has an interface to at least one ad object pool, which may be stationed on the same host running the software, or which may be contained in a connected or accessible remote repository. An ad pool contains dialog objects that represent advertisement audio or other messaging dialogs and prompts that may be selected and used at appropriate positions in a running voice application.

Ad server 1300 has a logical communication bus structure 1313 illustrated herein and adapted for communication between software and hardware components of a host node. It is noted that ad server 1300 may be provided as a dedicated node adapted solely for selecting and serving ad dialog according to embodiments of the present invention. Likewise, ad server 1300 may be provided as a software program that can be installed to run on a network node such as a PC, server node, or a voice portal or interface without departing from the spirit and scope of the invention.

Internal data layer 1304 of ad server 1300 contains a rules base 1305 adapted to hold data and caller behavioral rules. An enterprise may provide certain rules for ad selection based on information known about a particular caller type or data that is known about a particular caller. Likewise, if ad selection is based on behavioral traits of a caller, then there may be rules that address which ads may be served according to certain navigation patterns performed by the caller in interaction with the voice application. Rules 1305 may be updated to ad server 1300 over a network connection from an enterprise providing voice application services. The rules are consulted at each ad insertion point that references a pool of existing or potential advertisement dialogs.

Internal data layer 1304 of ad server 1300 has a data store 1306 adapted to hold static caller data and current caller behavioral statistics that may be relevant to a caller interacting with a voice application with respect to ad selection and insertion by server 1300. Store 1306 may be empty until a caller is detected and an instance of server 1300 is launched, at which time static data already known about the caller is sent to server 1300 from the enterprise or server 1300 or, from any repository containing the information at the time of launch. As server 1300 monitors the voice application progress, it may record caller navigation selections and may use that data along with behavioral rules to select an ad at the appropriate time during the interaction.

Processing layer 1307 of ad server 1300 has a central processing unit 1308 (provided by the host node). Ad server 1300 runs on processor 1308 and has an ad selection and serving component 1310 provided thereto and adapted to select an advertisement dialog after running an algorithm that weighs data from store 1306 against rules base 1305. As a result of the algorithm running, an ad from an ad pool may be identified and selected for delivery to the voice application.

An ad pool index 1309 may be provided in one embodiment so that an ad may be identified very quickly in the case of many available ads. For example, at an ad insertion point in a voice application, server 1300 runs ad selector/server 1310 and analyzes the available data. The result of analyzing such data is the identification of either (1) a particular pre-built ad that may be identified by ad number or some other description in the rules or (2) a required ad that is dynamically built to meet the business rule-specified requirements and then stored on the ad server. The identification may be checked against the ad index to select the ad for retrieval from the ad pool. Once retrieved the ad dialog or prompt may be placed in cache memory 1311 for service to the voice application interface. Once the interface running the voice application receives the selected ad dialog, then the voice application causes the ad dialog to be presented as a normal part of voice interaction with the caller.

The process described above may be completed without actually retrieving the audio or text dialog as the voice application need only know where the resource is located, in this case on the ad server. The voice application, in a preferred embodiment, accesses the advertisement on the ad server, and plays it for the caller. In this way, the voice application can present selected advertisements without a significant delay in dialog transition. The caller may interact with the selected advertisement according to the options built into the ad dialog. At the end of an ad dialog, there may be an option provided for taking a caller back to the pre-ad dialog, for terminating the interaction or to transfer the call to another interaction environment. In any case, the voice application does not retain the script invoking the advertisement dialog after a caller has successfully navigated it.

It will be apparent to one with skill in the art that server 1300 may be provided as an internal component to a voice interface, or as a remote component that communicates with a voice interface without departing from the spirit and scope of the present invention. Likewise, an ad server may include software for ad authoring. In such as case, a third party coordinate with a voice application author to create ad dialogs that can be accessed and used by the application wherein the location, identification and linking language of the created ads can be standardized. Therefore, a voice application may take a caller up to the ad insertion point referencing a specific ad pool and then pass off responsibility to an ad selector/server 1310, which selects and serves an ad dialog identification and location reference to the voice application. The voice application then accesses the resource and causes same to be presented to the caller.

One with skill in the art will recognize that an enterprise may create it's own ads for it's own voice applications, or may rely on ads created by a third party without departing from the spirit and scope of the present invention. Likewise the ad resources comprising the actual media files may be stored internally or externally from a voice interaction system and may be stored in a same repository as default dialogs.

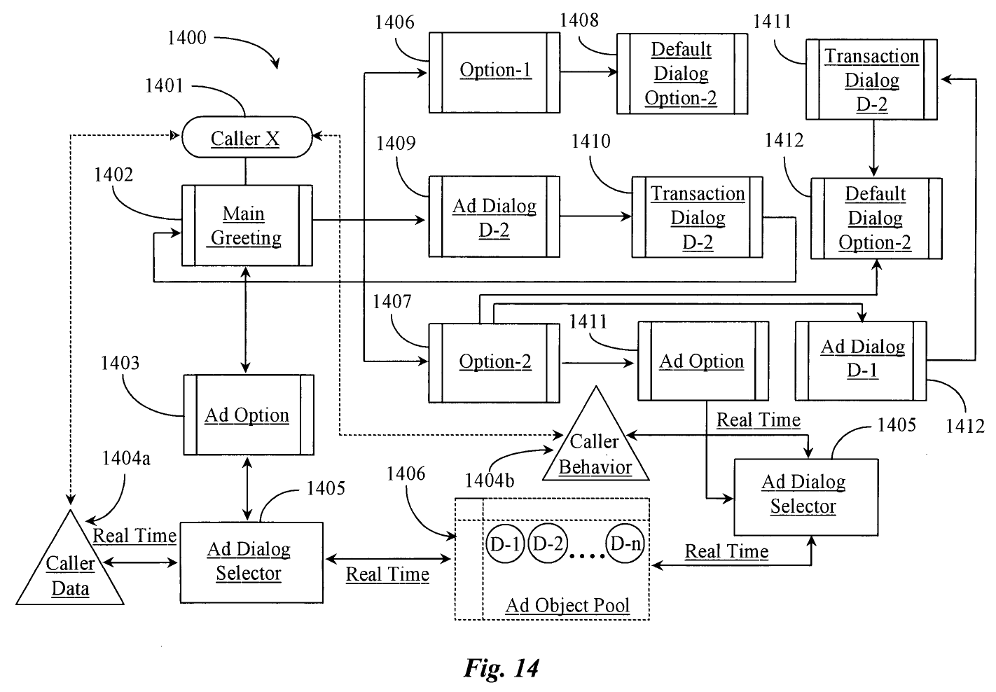

FIG. 14 is a block diagram 1400 illustrating logical system interaction points between a dynamic ad server and a caller according to an embodiment of the present invention. Diagram 1400 begins with a caller X (1401) beginning interaction with a voice application wherein a main greeting 1402 is first played to caller 1401. Main greeting 1402 may optionally contain an ad option 1403 along with default dialog options. Default dialog options offered in the main greeting 1402 may include option 1 (1406) and option 2 (1407). In one embodiment, ad option 1403 depends on caller acceptance in the voice interaction to be exercised or played.

To further explain, main greeting 1402 is typically played to every caller accessing the voice application. Options 1406 and 1407 may be presented as a single dialog asking the caller to choose which option to select. Ad option 1403 in this example may be played before options 1406 and 1407 are played, or it may be presented in the same dialog as the default options. A single option prompt may ask a caller, for example, would you like to hear your account balance, the last 5 transactions, or would you like hear about some new products and services being offered? In this case, caller 1401 may select ad option 1403.

As soon as caller 1401 selects the ad option, an ad selector 1405 is invoked and accesses caller data 1404a in real time for use in making an ad selection from an ad object pool 1406. It is noted herein and was described further above that a voice application may reference a specific ad object pool (grouping of ad dialogs) in the program language. This reference both calls the ad selector and gives reference to the identification of and, in some cases, location of the ad object pool from which the ad selector will select an ad. Once the ad selector decides which ad to select based on an analysis of caller data 1404a and consultation of the pre-set rules, ad selector retrieves, in this embodiment, one of ad objects D-1 through D-n from the pool and delivers the selected ad to the main greeting dialog portion 1402 of the voice application. In one embodiment, selector 1405 can retrieve and serve actual media to be played in a voice application. In a preferred embodiment, selector 1405 locates and serves an instruction to the voice application, the instruction identifies the ad and the location of the ad resource and the instruction for appending the script temporarily to get and play the ad resource files. In this logical diagram, it may be assumed that either method is applicable.

Main greeting 1402 now has an ad dialog (D-2) 1409, which it plays for caller 1401. Dialog 1409 may contain an acceptance option, which causes a transaction dialog 1410 (part of D-2) to be played for caller 1401, enabling the caller to pursue or make some other decision related to the selected advertisement offer. In this case after caller 1401 has completed a transaction related to the ad offer, he or she may select an option to go to default dialog option 1407 to hear the last 5 transactions performed on his or her account or to default dialog option 1406 to hear account balance information about his or her account. Alternatively, caller X may be brought back to the main greeting and may hear and be able to select from both default options 1406 and 1407. Transition instruction enabling navigation-after interacting with a dynamic advertisement dialog is part of the advertisement dialog itself and will not be retained by the voice application after the dialog terminates for a caller.

If caller 1401 was not presented with an ad option in main greeting 1402 and caller 1401 selected default option 2 (1407) for interaction, an advertisement option may then be presented to caller 1401. For example, an ad option 1411 may be played to caller 1401 after selection of option 1407. For example, there may be some delay while a system is retrieving some information for caller 1401. During the interim ad option 1411 may execute, calling ad selector 1405 to select and serve an ad based, perhaps on (1) caller profile information, (2) the navigation history of the caller, or (3) the instant navigation sequence exercised by the caller and recorded by the system during the current session.

In the above case, ad selector 1405 may access the current caller behavioral data and use that data against behavioral rules to identify an ad from ad object pool 1406 for service to the voice application. In this case, caller 1401 is presented with ad dialog D-1 (1412) while he or she is waiting for a system response to a previous selection. Caller 1401 may, if desired, proceed to a transaction dialog D-2 (1411) to conclude business related to the advertisement offer D-1. After concluding the transaction, caller 1401 may be brought back to the default dialog for option 2 where he or she may then hear the system response information fetched in the background while interacting with the dynamic advertisement dialog.

It will be apparent to one with skill in the art that offering an ad option whereupon a caller may elect or decline to hear an advertisement may be practiced in dynamic ad serving. Likewise, a caller may be forced to hear a dynamically selected ad before the system returns a result requested in a previous menu option. Moreover, an ad option may be executed in the interim while a result or system response related to a default selection is forthcoming. In this example, caller 1401 may avoid all advertisements by selection of dialog option 1 (1406) where there is no available ad insertion point. A forced dynamic ad selection may be executed automatically without providing any previous dialog or options regarding advertisements. In this case ad dialog selector 1405 is automatically called and executed transparently to the caller and the selected ad is presented to the caller regardless of caller behavior.

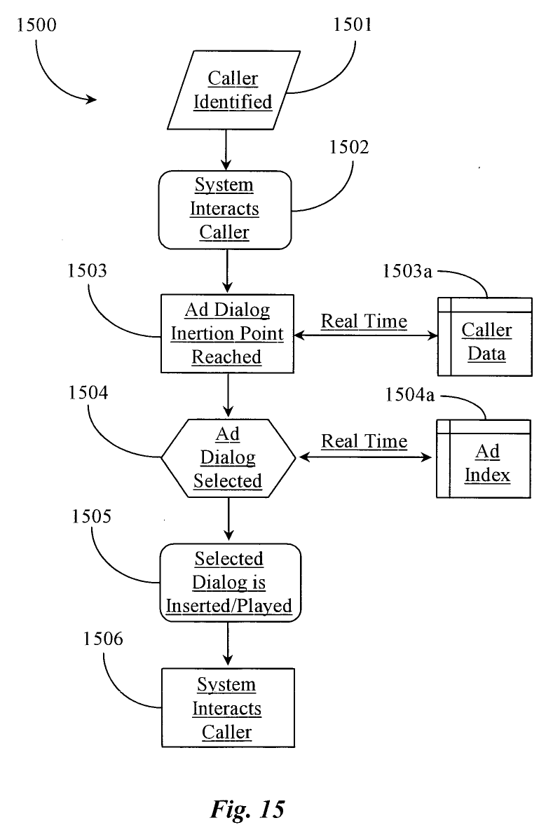

FIG. 15 is a process flow chart 1500 illustrating steps for selecting and serving a dynamic ad based on caller information according to an embodiment of the present invention. At step 1501 a caller accessing a voice application is identified. The identification of the caller is immediately forwarded to an ad server analogous to server 1300 of FIG. 13. Caller identification may be via one or a combination of automated number identification (ANI), caller password or personal identification number (PIN), or some other input or pre-known data that is part of a caller connection parameter to the voice interface. At this time any static data associated with the caller that may be known to the enterprise hosting the voice application is made available to the ad server. The ad server may also in this step access caller data from the enterprise, or from a local repository, or from internal data stores if provided. Some caller data may be provided along with caller identification at the time of connection.

At step 1502, the voice interface system, which may be a VXML enabled voice portal, an IVR, or another type of voice interfacing node capable of running a voice application interacts with the caller. In this step a static main dialog menu may be played and may be the same beginning menu played for all callers. During step 1502, an instance of ad server software analogous to SW 1220 or 1225 of FIG. 12 monitors the interaction activity, or more particularly, the position of the caller with respect to the voice application architecture.

At step 1503, the caller reaches an ad dialog insertion point during his or her navigation through the voice application. At step 1503 an ad dialog selector may automatically execute and begin a process of caller data analysis and ad selection. Prior to step 1503 there may be an ad option presented to a caller as part of the voice application dialog. The option may ask the caller if he or she is willing to hear an advertisement, but may also allow the caller to opt out of the advertisement presentation. If a caller has selected an option to hear an ad then the ad insertion mechanism is triggered.

Ad dialog selection involves analysis of caller-related data and processing of the data against a set of rules. Therefore, at step 1503, the ad dialog selector has reference to a specific ad pool and retrieves the applicable caller data from a repository 1503a or from an internal data source, if data is retained on a host of the ad-selection software. Caller data may be data that is pre-known about the caller and data that is provided by a caller during interaction with a voice interface. Caller behavioral data may also be used such as quantification of a caller's voice application navigation choices or patterns. This data may be observed and recorded during session interactions and may be appended to historical behavioral data previously recorded and retained.

At step 1504, the ad dialog selector selects an ad dialog from a pool of ad dialog resources 1504a that may be stored remotely or locally to the ad selection software. A particular pool of advertisements may be represented internally or externally by an ad index, which identifies and points to the locations of all of the ad resources stored. The advertisements comprising a pool are referenced in voice application code as an ad pool containing the sum of the included advertisements. A selected advertisement may be a series of audio files and voice application code for using those files in interaction with a caller. Text scripts may replace audio resources where those scripts are interpreted by TTS software and played using voice synthesis.

At step 1505, an ad dialog that has been selected in step 1504 is inserted into the running voice application specific to the caller for which it was selected and played for the caller. The advertisement may contain all of the resources and application code necessary to enable full interaction with the advertisement, including fulfillment related to a goal or goals of the advertisement. Advertisement dialog including the enabling voice application code for enabling interaction with the ad dialog may be authored by the same enterprise that authored the host voice application, or by a third party author that has authority to use the voice application code libraries. In this way, third-party entities may create target advertisement content and code that will be compatible with any voice application. All that is required in the voice application is (1) an ad insertion point that references a specific ad pool, an ad selector that selects from the pool and delivers the selected ad to the voice application, and (3) one or more business rules that instruct the ad selector which ad to select for any specific customer, based on results of the caller's data analysis. An ad pool may contain many advertisement dialogs to select from. Moreover an ad pool may reference as few as two differing advertisement dialogs.

At step 1506, the voice interfacing system running the voice application interacts with the caller using the selected advertisement dialog. This interaction may include further options for a caller to select from, including transaction dialogs, secure payment dialogs, and the like. At the end of an inserted dialog, the caller may be directed back to a default menu of the host voice application. In some embodiments, a caller may be given an option at the end of an advertisement interaction to end the call or to navigate to other default portions of the main menu of the host application. After traversing the inserted ad dialog, the dialog and application code enabling interaction with the dialog is, in a preferred embodiment, not retained by the host voice application. In this way, advertisement dialogs may be uploaded to a cache memory of the host machine and played from cache, whereupon when completed they may be deleted from cache.

In one embodiment of the present invention, an ad pool may be a compilation of advertisements that are not all stored in a same location, or even on a same host repository. For example, more than one third parties may have advertisements in an ad pool wherein those ads are located by hyperlink and inserted in the ad index referencing the advertisements. There are many possibilities.

It will be apparent to one with skill in the art that process 1500 may contain more steps and sub-steps than are illustrated in this example without departing from the spirit and scope of the present invention. For example, steps 1503 and 1504 may be further broken down into sub-routines for navigation and retrieval of actual advertisement media files and upload and linking to a host application for caller presentation. Likewise, other steps may be introduced depending on actual machine location, memory location and format that advertisements for insertion are maintained. In one embodiment, ads may be uploaded from an on-line resource wherein universal resource locators (URL) and universal resource indicators (URI) parameters are used to locate and retrieve those advertisements.

The methods and apparatus of the present invention can be practiced using a variety of voice automation systems, including VXML-enabled voice portals and interactive voice recognition and response systems that may be Web-based or otherwise hosted on a data packet network, or may be telephony-based in a switch-connected telephony network or in a wireless telephony carrier environment. Methods and apparatus for maintaining and organizing ad-pool resources for possible deployment may also vary considerably without departing from the spirit and scope of the present invention. For example, ads may be pooled physically together on the same repository, externally or internally accessible to a voice interaction interface system. Likewise, ad resources classed as a pool may be distributed in different repositories of a same machine or in different machines on a network and linked together by an ad index that provides identification and location references for location and retrieval of advertisement dialogs or prompts to be inserted into a running voice application.

The method and apparatus of the present invention, in light of many possible embodiments, some of which are described herein should be afforded the broadest possible scope under examination. The spirit and scope of the present invention is limited only by the following claims.

1. A system for selecting a voice dialog, which may be an advertisement or information message, from a pool of voice dialogs and for causing the selected voice dialog to be utilized by a voice application for presentation to a caller during an automated voice interactive session comprising:
a voice-enabled interaction interface hosting the voice application; and
a sever monitoring the voice-enabled interaction interface for selecting the voice dialog and for serving at least identification and location of the dialog to be presented to the caller via the voice application.

2. The system of claim 1, wherein the voice-enabled interaction interface is an interactive voice response unit hosted in a telephone network.

3. The system of claim 1, wherein the voice-enabled interaction interface is a voice portal hosted on one of the Internet, an Intranet, or on a Local Area Network.

4. The system of claim 1, wherein the voice application is a Voice Extensible Markup Language-based application and the voice interface is VXML-enabled.

5. The system of claim 1, wherein the server is a software instance running on a node separate from but having network access to the voice-enabled interaction interface.

6. The system of claim 1, wherein the server is a software instance running on the voice-enabled interaction interface.

7. The system of claim 1, wherein the voice dialogs comprise one or more text scripts that are recognized and executed as voice using a text-to-speech conversion method when presented to a caller.

8. The system of claim 1, wherein the voice dialogs comprise one or more pre-recorded or dynamically recorded voice files, including voice application code for enabling interaction with the voice dialog.

9. The system of claim 1, wherein the host running the voice application retrieves and presents a selected voice dialog based on served identification and location information of the voice dialog.

10. The system of claim 1, wherein the sever retrieves and serves the voice dialog to the host running the voice application whereupon the voice application then presents the voice dialog to the caller in the voice-enabled interaction.

11. The system of claim 1, wherein the voice application code references a pool of two or more voice dialogs and the server selects which voice dialog from the pool will be presented based on analysis of caller data against a set of rules.

12. A software instance for selecting a voice dialog, which may be an advertisement or an information message, from a pool of voice dialogs and for causing the selected voice dialog to be utilized by a voice application for presentation to a caller during an automated interactive voice session with the caller comprising:
a portion for accepting and analyzing data about the caller;
a portion for selecting a voice dialog; and
a portion for serving at least identification and location of the selected voice dialog to the voice application.

13. The software instance of claim 12, wherein the voice application is deployed to and executable on an interactive voice response unit hosted in one of a telephone network, an Intranet network, or a Local Area Network.

14. The software instance of claim 12, wherein the voice application is deployed to and executable on a voice portal hosted on the Internet network.

15. The software instance of claim 12, wherein the voice application is a Voice Extensible Markup Language-based application and the voice interface is VXML-enabled.

16. The software instance of claim 12, installed and executable from a node separate from but having network access to the voice-enabled interaction interface.

17. The software instance of claim 12, installed and executable from the voice-enabled interaction interface.

18. The software instance of claim 12, wherein the voice dialogs comprise one or more text scripts that are recognized and executed as voice using a text-to-speech conversion method when presented to a caller.

19. The software instance of claim 12, wherein the voice dialogs comprise one or more pre-recorded or dynamically recorded voice files including voice application code for enabling interaction with the voice dialog.

20. The software instance of claim 12, wherein the portion for accepting and analyzing data about the caller accepts historical data about the caller.

21. The software instance of claim 12, wherein the data about the caller may include one or a combination of profile data, historical data, including historical activity, historical behavioral data, and real time behavioral data.

22. The software instance of claim 12, wherein the portion for selecting a voice dialog utilizes the caller data, a set of rules, and the location reference to the voice dialog pool.

23. The software instance of claim 12, wherein the portion for serving the selected voice dialog serves the actual resource files and application code of the selected voice dialog.

24. The software instance of claim 21, wherein the portion for accepting and analyzing data about the caller executes an algorithm that compares data about the caller against a set of rules.

25. A method for selecting a voice dialog, which may be an advertisement or an information message, from a voice dialog pool for use in an automated voice session presentation to a caller comprising steps of:
(a) identifying the caller;
(b) accepting data about the caller;
(c) analyzing the accepted data and consulting at least one rule; and
(d) selecting a voice dialog based on the result of consultation.

26. The method of step 25, wherein in step (a), the caller is identified by one or a combination of telephone number, password, or personal identification information.

27. The method of step 25, wherein in step (b), data about the caller is forwarded to the host machine executing the method wherein the data is static data known about the caller.

28. The method of step 25, wherein in step (b), data about the caller is forwarded to the host machine executing the method wherein the data is one or a combination of profile data, historical data, including historical activity, historical behavioral data, and real time behavioral data.

29. The method of step 28, wherein in step (b), the behavioral data includes navigation data observed during caller navigation of at least one voice application menu option.

30. The method of step 25, wherein in step (c), an algorithm compares data results against the at least one rule and in step (d), the selection is made according to results of the comparison.

31. A method for causing a voice dialog, which may be an advertisement or an information message, selected from a voice dialog pool to execute in an interactive voice application in a state of interaction with a caller comprising steps of:
(a) serving at least identification and location information of the selected voice dialog to the voice application;
(b) upon receipt of the identification and location information, retrieving the voice dialog from its location reference in the pool;
(c) upon receipt of the voice dialog, inserting same into the voice application; and,
(d) executing the voice dialog to play for the caller.

32. The method of claim 31 wherein in step (a), the identification and location information is referenced in the voice application code that also references the specific pool of voice dialogs.

33. The method of claim 31 wherein in step (a) the identification and location information is available from a dialog index associated with the voice dialog pool, the index providing identification and location for all of the voice dialogs in the pool.

34. The method of claim 31 wherein in step (b), the pool is a logical association of voice dialogs located in different physical hosts accessible over one of an Internet, an Intranet or a Local Area Network.

35. The method of claim 31 wherein in step (b), the pool is a physical pool of voice dialogs located in a same physical host.

36. The method of claim 31 wherein in step (c), the voice dialog has linking and execution code therein for attaching to a dialog insertion point in a voice application and executing the voice dialog once attached.
